(19) United States
(12) Patent Application Publication
(10) Pub. No.: US 2004/0081440 A1
(43) Pub. Date: Apr. 29, 2004

(54) Photo sticker vending machine and method, sticker sheet and sticker sheet unit

(76) Inventors: Tetsuya Miwa, Kyoto (JP); Katsuyuki Inage, Kyoto (JP); Hajima Nishidai, Kyoto (JP); Eiji Kuroda, Osaka (JP); Masamichi Akima, Kyoto (JP)

Correspondence Address: DICKSTEIN SHAPIRO MORIN & OSHINSKY LLP, 2101 L STREET NW, WASHINGTON, DC, 20037-1526, US

(21) Appl. No.: 10/637,535

(22) Filed: Aug. 11, 2003

(30) Foreign Application Priority Data
Aug. 12, 2002 (JP) 2002-234455

(51) Int. Cl. G03B 15/00

(52) U.S. Cl. 396/2

(57) ABSTRACT

A “theme” conceptually representing a pose and/or expression of an object is displayed on a image capture monitor as text information. A user checks the “theme” displayed before image capture starts and creates his/her pose and/or expression associated with the theme. The image capture is performed in response to a user instruction to start image capture, and a photograph with a composition associated with the “theme” iscaptured. In graffiti processing on an image, which is started at the end of the image capture processing, text corresponding to the “theme” having been given for capturing the image can be input onto the captured image. The invention can be applied to a photo sticker vending machine.

### CROSS-REFERENCE TO RELATED APPLICATIONS

This application claims priority under 35 USC §119 to Japanese patent application No. 2002/234,455, filed Aug. 12, 2002, the entire contents of which is incorporated herein by reference.

### FIELD OF THE INVENTION

The present invention relates to a photo sticker vending machine and method of operation, a sticker sheet and a sticker sheet unit, which allow a user to create a photographic composition so that more interesting photographic images can be provided to the user.

### BACKGROUND OF THE INVENTION

Conventionally, a photo sticker vending machine such as “Print Club (Registered Trademark)” has been known. By using the photo sticker vending machine, an image of a user is taken, combined with a prepared frame image and is printed on a sticker sheet, for example.

A user can pose and/or arrange an expression for a photo in accordance with the counting down such as “five, four, three, two and one” output by voice or displayed on a screen by a general photo sticker vending machine.

However, the photographic image by using the conventional photo sticker vending machine lacks interest. This is because the photographic image is performed at a signal, which is essentially the same as the human taking a photographic image at a signal such as “Pose!” by a photographer (human).

This kind of photo sticker vending machine may be used by a group of people. For example, when each person poses based on the same “theme” in order to take one unified photo of the poses of all of the members of group, somebody in the group must suggest the theme, which takes time. Then, the time limit set for shooting is disadvantageously wasted.

### BRIEF SUMMARY OF THE INVENTION

The present invention was made in view of these problems. It is an object of the invention to provide more interesting photographic images by allowing a user to create the photographic composition.

According to one aspect of the invention, there is provided a photo sticker vending machine, including an output unit for outputting a theme conceptually representing a photographic composition of an object, and a photographic unit for capturing the photographic image of the object to which the theme is given by the output unit.

Here, the photographic composition refers to a posture, pose or expression of a user, which is an object in a photograph to be taken. When multiple users use the photo sticker vending machine, the photographic composition also refers to standing positions of the users.

The output unit may output the theme by text or by voice.

The photo sticker vending machine may further include a selecting unit for randomly selecting a predetermined number of the themes. The output unit preferably outputs the theme selected by the selecting unit.

Thus, an unexpected theme can be selected, and the creation of the pose and/or expression associated with the theme becomes more difficult. Therefore, a game characteristic is given to the photographic image capture itself.

The photo sticker vending machine may further include a display unit for displaying a plurality of the themes. In this case, the output unit outputs a theme selected from the plurality of the themes displayed by the display unit.

The photo sticker vending machine may further include a graffiti unit for doing graffiti on an image by the photographic capturing unit. In this case, the graffiti unit inputs, to the image for graffiti, information representing the theme corresponding to the image for graffiti.

The photo sticker vending machine may further include a printing unit for printing on a sticker sheet an image taken by the photographic capturing unit or an image on which graffiti are created by the graffiti unit. In this case, the printing unit prints the theme corresponding to an image to be printed near the image to be printed.

Thus, a user can remember a theme given in shooting each image when the user looks at the sticker sheet later.

According to another aspect of the invention, there is provided a photo shooting method in a photo sticker vending machine, including the steps of outputting a theme conceptually representing a photographic composition to an object, and a capturing of the photographic image of the object to which the theme is given by the output unit.

In this case, since a user as an object must create his/her pose and/or expression based on a given theme, a game characteristic is given to the photographic capturing itself. Therefore, more interesting photographic image capturing can be provided to the user.

When a group of people performsphotographic image capturing, the poses and expressions for the image capturing may be discussed in the group. Therefore, giving the photographic image capturing a theme may provide an opportunity for better communication.

A group of people may want to take a photograph in which all of the people have unified poses based on one “theme”. Here, since a subject is given by the photo sticker vending machine, they do not have to think about the theme.

According to another aspect of the invention, there is provided a sticker sheet to be printed by a photo image capturing method in a photo sticker vending machine, the method including the steps of outputting a theme conceptually representing a photographic composition of an object, and photographically capturing the image of the object to which the theme is given by the output unit.

According to another aspect of the invention, there is provided a sticker sheet unit used in a photo sticker vending machine, the machine including an output unit for outputting a theme conceptually representing a photographic composition to an object, and a photographic capturing unit for capturing the image of the object to which the theme is given by the output unit, the sticker sheet unit including an identification information storing unit for storing identification information for identifying the sticker sheet unit. In this case, the sticker sheet unit is usable when the identification information stored by the identification information storing unit is authenticated by the photo sticker vending machine.

The identification information storing unit may include a memory such as an IC tag (control tag) and an IC card and stores a unique ID as identification information.

As described above, a sticker sheet unit is usable only when the identification information is authenticated such that a unit compliant with the photo sticker vending machine according to the invention is usable. Therefore, the use of so-called non-genuine products can be suppressed. Furthermore, when a barcode or the like is given to the sticker sheet unit, the genuine product and non-genuine product may be distinguished based on the barcode.

According to the invention, more interesting photographic image capturing can be provided.

Furthermore, according to the invention, an opportunity for better communication in a group can be provided, and more interesting photographic image capturing in the group can be achieved.

### BRIEF DESCRIPTION OF THE DRAWINGS

FIG. 1 is a perspective diagram showing an example of an exterior of an image printing apparatus according to the invention;

FIG. 2 is a perspective diagram showing an example of another exterior of an image printing apparatus according to the invention;

FIG. 3 is a diagram showing an example of an arrangement in the image printing apparatus in FIG. 1 from the left side;

FIG. 4 is a diagram showing an example of an arrangement in the image printing apparatus in FIG. 1 from the above;

FIG. 5 is a block diagram showing a construction example of the image printing apparatus in FIG. 1;

FIG. 6 is a block diagram showing a construction example of a control device in FIG. 5;

FIG. 7 is a flowchart for describing customer receiving processing of the image printing apparatus;

FIG. 8 is a flowchart for describing a detail of the photographic image capturing processing to be performed at step S2 in FIG. 7;

FIG. 9 is a flowchart following the flowchart in FIG. 8 for describing the detail of the photographic image processing to be performed at step S2 in FIG. 7;

FIG. 10 is a flowchart following the flowchart in FIG. 8 for describing the detail of processing to be performed at step S2 in FIG. 7;

FIG. 11 is a flowchart following the flowchart in FIG. 8 for describing the detail of processing to be performed at step S2 in FIG. 7;

FIG. 12 is a diagram showing a display example of a photographic image capturing monitor to be displayed at step S11 in FIG. 8;

FIG. 13 is a diagram showing a display example of the photographic image capturing monitor to be displayed at step S13 in FIG. 8;

FIG. 14 is a diagram showing a display example of the photographic image capturing monitor to be displayed at step S15 in FIG. 8;

FIG. 15 is a diagram showing a display example of the photographic image capturing monitor to be displayed at step S18 in FIG. 8;

FIG. 16 is a diagram showing a display example of the photographic image capturing monitor to be displayed at step S19 in FIG. 8;

FIG. 17 is a diagram showing another display example of the photographic image capturing monitor to be displayed at step S19 in FIG. 8;

FIG. 18 is a diagram showing a display example of the photographic image capturing monitor to be displayed at step S22 in FIG. 8;

FIG. 19 is a diagram showing a display example of the photographic image capturing monitor to be displayed at step S24 in FIG. 8;

FIG. 20 is a diagram showing a display example of the photographic image capturing monitor to be displayed at step S26 in FIG. 9;

FIG. 21 is a diagram showing a display example of the photographic image capturing monitor to be displayed at step S28 in FIG. 9;

FIG. 22 is a diagram showing a display example of the photographic image capturing monitor to be displayed at step S31 in FIG. 9;

FIG. 23 is a diagram showing a display example of the photographic image capturing monitor to be displayed at step S33 in FIG. 9;

FIG. 24 is a diagram showing a display example of the photographic image capturing monitor to be displayed at step S33 in FIG. 9;

FIG. 25 is a diagram showing a display example of the photographic image capturing monitor to be displayed at step S35 in FIG. 10;

FIG. 26 is a diagram showing a display example of the photographic image capturing monitor to be displayed at step S44 in FIG. 10;

FIG. 27 is a diagram showing a display example of the photographic image capturing monitor;

FIG. 28 is a diagram showing a display example of the photographic image capturing monitor to be displayed at step S46 in FIG. 11;

FIG. 29 is a flowchart for describing a detail of graffiti processing to be performed at step S3 in FIG. 7;

FIG. 30 is a diagram showing a display example of a graffiti screen to be performed at step S61 in FIG. 29; and

FIG. 31 is a diagram showing an example of a sticker sheet.

### DETAILED DESCRIPTION OF THE INVENTION

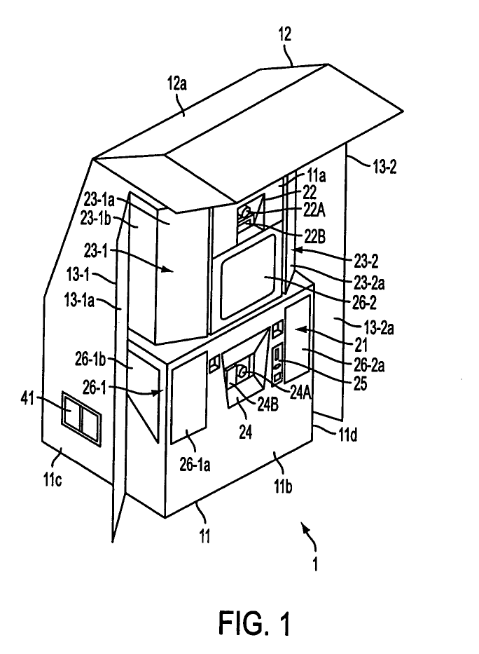

FIG. 1 is a perspective diagram showing a construction example of a photo sticker vending machine 1 according to the invention.

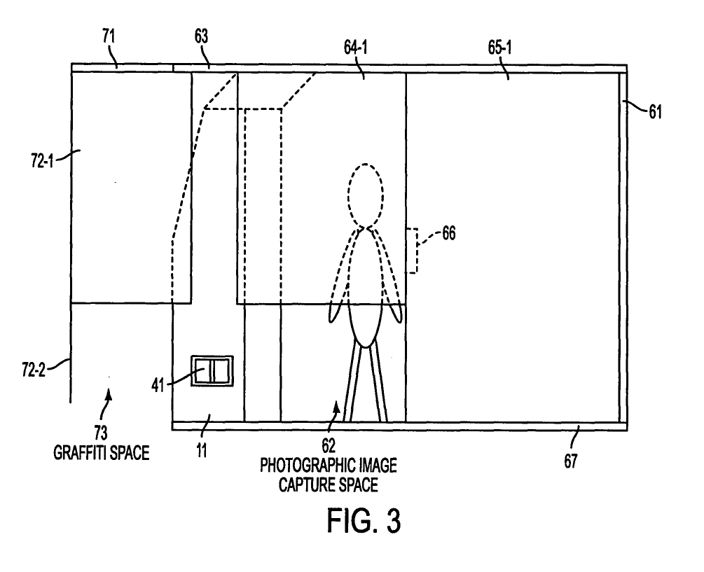

The photo sticker vending machine 1 basically includes a cabinet 11, an illuminating apparatus 12 and reflectors 13-1 and 13-2. As described later, a background panel 61 (see FIG. 3) is spaced apart from the cabinet 11 at a predetermined distance. The space between the cabinet 11 and the background panel 61 is a photographic image capture space 62 (see FIG. 3) where a user as an object performs photographic image capture processing.

A surface 11a on the upper half of the cabinet 11 faces the photographic image capture space 62 and has a photographic image capturing monitor 21 including a liquid crystal display (LCD) and a cathode-ray tube (CRT). The photographic image capturing monitor 21 displays different messages for guiding a photographic image capturing method, for example, in accordance with the stage of advancement. When a predetermined photographic image capturing mode is selected, the photographic image capturing monitor 21 displays a “theme” (subject) conceptually representing the pose, expression and/or posture of a user, that is, conceptually representing the photographic composition. Therefore, after the user checks the theme, the user creates the pose and/or expression associated with the theme. Then, the user takes a photograph (image) of the user having the created pose and/or expression. The details of the photographic image capture processing to be performed in accordance with a displayed theme will be described later with reference to flowcharts.

Since the photographic image capturing monitor 21 displays an image of the photographic result, the user can select an image to draw (or edit) from displayed images. As described later, a user can move to the back of the photo sticker vending machine (the opposite side of the shooting space 62 through the cabinet 11) after the photographic image capturing and can draw by inputting preferred text and/or figures on a photographic image.

A depression toward the inside of the cabinet 11 is provided immediately above the photographic image capturing monitor 21. A photographic image capturing portion 22 is provided in the depression. The photographic image capturing portion 22 includes a charge-coupled device (CCD) 22A and an image display portion 22B, such as an LCD, immediately below the CCD 22A. The CCD 22A and image display portion 22B are provided on a surface bending forward such that the entire area around the standing position (in front of surfaces 11a and 11b) of a user can be looked over and an image can be taken from the above of the CCD 22A or such that the user can check an image to be displayed on the image display portion 22B.

An image of an object is captured by the CCD 22A in the photographic image capturing portion 22, and the image (moving image) is displayed by the image display portion 22B in real time. At a predetermined photographic image capturing time, a photograph is taken by the CCD 22A, and an image of a user is stored in the photo sticker vending machine 1 as a still image. Since the image display portion 22B is provided near the CCD 22A, the user can take a photograph by checking an image of the user, which is displayed by the image display portion 22B, at the same time.

In the cabinet 11, the photographic image capturing monitor 21 is provided between a pair of left and right illuminating apparatus 23-1 and 23-2. Thus, an amount of light required by a user for capturing a photographic image in the photographic image capture space 62 is irradiated. For example, each of transparent surfaces 23-1a and 23-1b of the illuminating apparatus 23-1 is a thin plate of translucent resin. Thus, the light emitted by the illuminating apparatus 23-1 within the cabinet 11 passes through the transparent surfaces 23-1a and 23-1b toward the outside.

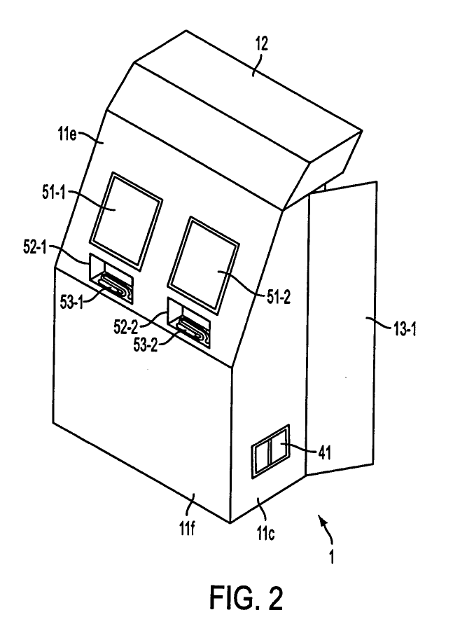

The transparent surface 23-1a from the side in contact with the surface 11a to the opposite side gradually is directed to the back surfaces (surfaces 11e and 11f in FIG. 2) of the cabinet 11. Thus, the light emitted from the inside of the cabinet 11 through the transparent surface 23-1a can uniformly reach to the left corner of the photographic image capture space 62. The transparent surface 23-1b and a left side 11c of the cabinet 11 are substantially in the same plane. The light emitted through the transparent surface 23-1b is reflected by a reflecting surface 13-1a, which directs light to the photographic image capture space 62, of the reflector 13-1 and irradiates the inside of the photographic image capture space 62.

The illuminating apparatus 23-2 has symmetrically the same construction as that of the illuminating apparatus 23-1. The light emitted through a reflector 23-2a is arranged to uniformly reach the right corner of the photographic image capture space 62. A transparent surface is provided substantially in the same plane as that of the right side 11d of the cabinet 11 at the position of the illuminating apparatus 23-2 corresponding to the transparent surface 23-1b of the illuminating apparatus 23-1. The light emitted through the transparent surface is reflected by the reflecting surface 13-2a of the reflector 13-2 and irradiates the photographic image capture space 62.

The reflecting surface 13-1a of the reflector 13-1 and the reflecting surface 13-2a of the reflector 13-2 are in a color such as white. Thus, the light emitted from the illuminating apparatus 23-1 and 23-2 can be efficiently reflected by the reflecting surfaces 13-1a and 13-2a to the photographic image capture space 62.

The surface 11b on the lower half of the front of the cabinet 11 has a depression toward the inside of the cabinet 11. A photographic image capturing portion 24 is provided in the depression similar to the photographic image capturing portion 22. In other words, the photographic image capturing portion 24 includes a CCD 24A and an image display portion 24B for displaying moving images captured by the CCD 24A. The CCD 24A and image display portion 24B are provided on a slightly inclining surface. Therefore, an upwardly takenimage in which an object is taken diagonally from the bottom is obtained.

In this way, by using the photographic image capturing portion for capturing an image of an object from various angles, a user does not have to adjust the angle of the photographic image capturing apparatus in order to capture images from various angles.

A coin slot 25 is provided on the immediate right side of the photographic image capturing portion 24. When a user uses the photo sticker vending machine 1 for shooting, the user needs to insert a predetermined amount of money into the coin slot 25.

The photographic image capturing portion 24 and coin slot 25 are provided between a pair of left and right illuminating apparatus 26-1 and 26-2 on the lower surface 11b of the cabinet 11. The illuminating apparatus 26-1 and 26-2 irradiate the foot of a user in front of the cabinet 11. For example, transparent surfaces 26-1a and 26-1b of the illuminating apparatus 26-1 are a thick plate of translucent resin like the illuminating apparatus 23-1. The light emitted from the illuminating apparatus 26-1 passes through the transparent surfaces 26-1a and 26-1b toward the outside.

The light emitted through the transparent surface 26-1a directly irradiates in the vicinity of the foot of a user. The light emitted through the transparent surface 26-1b substantially in the same plane as that of the left side 11c is reflected by the reflecting surface 13-1a of the reflector 13-1. Then, the reflected light irradiates the internal lower portion of the photographic image capturing space 62. The irradiating apparatus 26-2 symmetrically has the same construction as that of the irradiating apparatus 26-1. The light having passed through the transparent surface 26-2a directly irradiates in the vicinity of the foot of a user. A transparent surface is provided substantially in the same plane as that of the right side 11d, like the transparent surface 26-1b of the illuminating apparatus 26-1. Light passes through the transparent surface and is reflected by the reflecting surface 13-2a of the reflector 13-2. Then, the light irradiates the internal lower portion of the photographic image capturing space 62.

The illuminating apparatus 12 on the top surface of the cabinet 11 internally emits light. The light passes through one surface (not shown, of the illuminating apparatus 12, facing toward the surface 12a) and irradiates a user diagonally from the above. The illuminating apparatus 12, illuminating apparatus 23-1 and 23-2 and illuminating apparatus 26-1 and 26-2 operate in connection with the CCD 22A or CCD 24A such that enough light can be irradiated towards an object when an image iscaptured.

A photo sticker ejecting port 41 is provided at the bottom of the left side 11c. A predetermined number of captured images having graffiti are printed in a predetermined size on one sticker sheet. Then, the resulting photo sticker sheet is ejected from the sticker ejecting port 41.

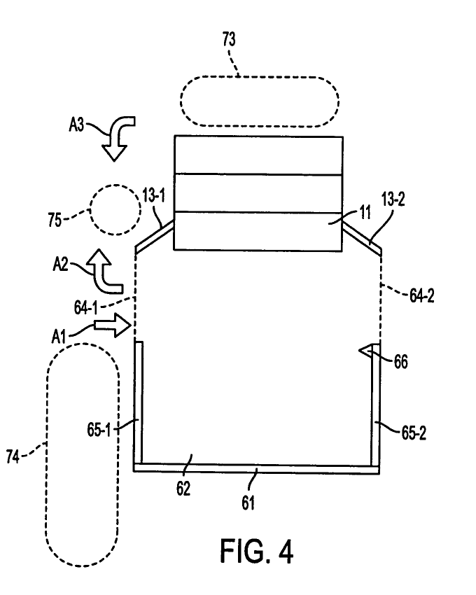

A remote controller 66 (FIG. 4) is provided at a position at a predetermined height on the right side panel 65-2 (FIG. 4) in the right front of the cabinet 11 (the right side of a user facing toward the cabinet 11). A user manipulates different buttons on the remote controller 66 in accordance with instructional messages displayed on the photographic image capture monitor 21 to advance the photographic image capture processing. In other words, a user can advance photographic image capture processing by manipulating the remote controller 66 without approaching the cabinet 11. Various kinds of information input from the remote controller 66 are supplied to the photo sticker vending machine 1 through a cable under flooring 67 (FIG. 3).

The remote controller 66 has an O-button, an X-button and an arrow button (up-down and left-right button). The O-button is manipulated to cause one of a plurality of choices to be displayed on the photographic image capturing monitor 21. The X-button is manipulated for canceling a selection that has been made. The arrow button is manipulated to move a cursor displayed on the photographic image capturing monitor 21 vertically and/or horizontally. Additionally, a photographic image capture start button may be provided, which is manipulated to startcapturing a photographic image. A touch-pen is provided near the photographic image capturing monitor 21. The touch-pen may be used to directly depress different buttons displayed on the photographic image capturing monitor 21 to advance the image capture processing.

FIG. 2 is a perspective diagram showing a construction example of the side of surfaces 11e and 11f opposite of the surfaces 11a and 11b of the photo sticker vending machine 1.

Here, the side of the surfaces 11a and 11b is the front of the photo sticker vending machine 1 while the side of the surfaces 11e and 11f is the back of the photo sticker vending machine 1.

Graffiti monitors 51-1 and 51-2 are horizontally aligned on the slanting surface 11e substantially in the upper half of the cabinet 11. A storage 52-1 is provided under the graffiti monitor 51-1 and stores an input pen 53-1 for drawing an image by directly pressing the input pen 53-1 against the graffiti monitor 51-1. Similarly, a storage 52-2 is provided under the photographic image capturing monitor 51-2 and stores an input pen 53-2 for drawing an image by directly pressing the input pen 53-2 against the graffiti monitor 51-2.

Images shot and selected to do graffiti are displayed on the graffiti monitors 51-1 and 51-2 after the photographic image capture processing ends. A touch-panel is provided over each of the graffiti monitors 51-1 and 51-2, and a user can freely write (input) text and figures on the displayed images by using the input pens 53-1 and 53-2.

Each of the graffiti monitors 51-1 and 51-2 displays an image to do graffiti and buttons for selecting various kinds of graffiti tools. When the buttons are manipulated and graffiti are drawn on the image (that is, when the image is edited), each of the graffiti monitors 51-1 and 51-2 displays the image having graffiti, which is created in accordance with inputs.

The input pens 53-1 and 53-2 are arranged to be compliant with the type of position detection (such as resistive-film type and ultrasonic type) of the touch panels on the graffiti monitors 51-1 and 51-2.

FIG. 3 is a diagram showing an example of arrangement of the photo sticker vending machine 1 viewed from the left side.

A ceiling member 63 covers the top of the photographic image capture space 62. The rear half, close to the background panel 61 on the left side of the photographic image capture space 62 is entirely covered by a left side panel 65-1. On the other hand, the rear half close to the background panel 61 on the right side is entirely covered by a right side panel 65-2 (FIG. 4).

The front half on the left side of the photographic image capture space 62 is covered by a retractable curtain 64-1 extending downward from the ceiling member 63 to a predetermined length. In other words, after a user opens the curtain 64-1 and enters to the photographic image capture space 62, the user closes the curtain 64-1 and performs shooting processing. At the end of the photographic image capture processing, the user again opens the curtain 64-1 and exits from the photographic image capture space 62. Then, the user moves to the front of the graffiti monitors 51-1 and 51-2, which is a graffiti space 73.

The interior surface of the photographic image capture space 62 having the above-described construction (that is, the interior surfaces of the background panel 61, ceiling member 63, side panels 65-1 and 65-2 and so on) is a color such as white or blue such that only the area of the user can be extracted by so-called Chromakey processing from the captured image.

The graffiti space 73 is provided at a position facing the surfaces 11e and 11f. A user moves to the graffiti space 73 after photographic image capture to do graffiti. A retractable curtain 72-1 is attached to a curtain frame 71 so as to prevent the interior of the graffiti space 73 from being exposed to the outside. The curtain 72-1 is substantially in the same plane as that of the left side 11c. The curtain 72-2 faces toward and is spaced apart from the surface 11e by a predetermined distance. In this example, the curtain frame 71 is provided substantially in the same plane as that of the ceiling member 43.

FIG. 4 is a plan view of an arrangement example of the photo sticker vending machine 1.

The movement of a user from the beginning of photographic image capture to the receipt of a sticker sheet will be described with reference to FIG. 4.

In order to use the photo sticker vending machine 1, a user enters the photographic image capture space 62 as indicated by an open arrow A1 and performs photographic image capture processing. For example, when the photographic image capture space 62 is in use, a user desiring to use the photo sticker vending machine 1 next must wait in an waiting space 74 next to the side panel 65-1, for example, until the shooting space 62 becomes vacant.

After the user selects a predetermined number of images for graffiti and finishes the shooting, the user exits from the photographic image capture space 62 as indicated by an open arrow A2. Then, the user moves to the graffiti space 73 at the back of the photo sticker vending machine 1.

Here, the user who has been waiting in the waiting space 74 (who has been waiting for the photographic image capture space 62 to become vacant) enters to the graffiti space 73 after another user who has used the photographic image capture space 62 moves to the graffiti space 73.

As described above, the graffiti monitors 51-1 and 51-2 can be checked from the graffiti space 73. The graffiti monitors 51-1 and 51-2 display images captured and selected in the photographic image capture space 62. Therefore, the user can create graffiti on the captured images on the graffiti monitors 51-1 and 51-2. After the user finishes creating graffiti, the user moves to a print waiting space 75 as indicated by an open arrow A3. The print waiting space 75 faces the left side 11c of the photo sticker vending machine 1. The user waits until the image having graffiti is printed on a sticker sheet and is supplied.

When the sticker sheet is supplied from the sticker ejecting port 41, the user receives the sticker sheet. Then, the use of the photo sticker vending machine 1 ends. The navigation of these movements is given through the photographic image capture monitor 21, the graffiti monitors 51-1 and/or 51-2 or speakers, not shown.

As described above, the space for capturing photographic images, the space for doing graffiti and the space for waiting for the completion of printing are provided in front of different surfaces of the photo sticker vending machine 1. Thus, photographic image capture processing, graffiti processing and printing processing can be implemented simultaneously, and the rate of turnover of the customers using the photo sticker vending machine 1 can be higher than that of the case where those kinds of processing are performed in one space. Furthermore, a group of users can take a longer time for shooting processing and graffiti processing.

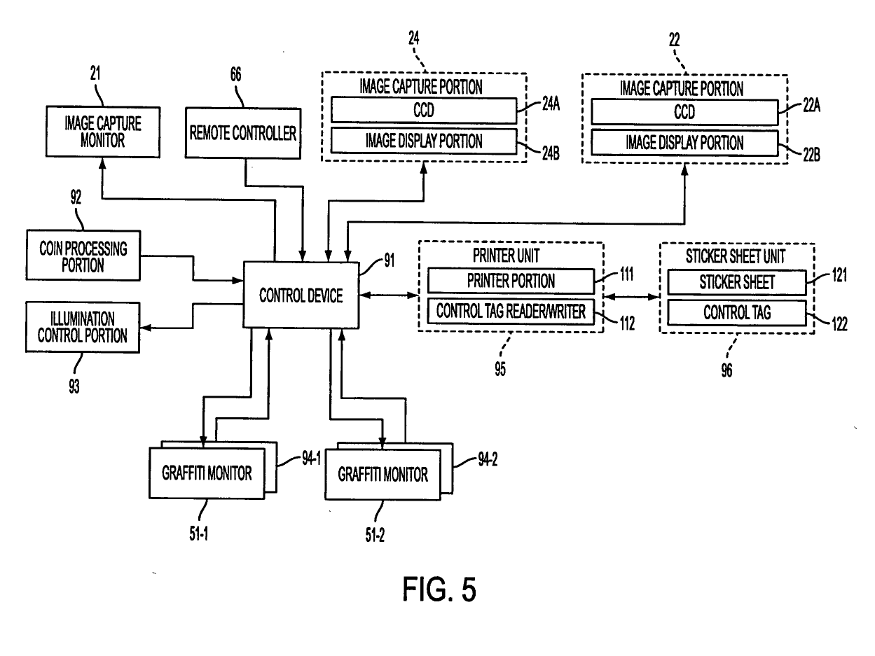

FIG. 5 is a block diagram showing an internal construction example of the photo sticker vending machine 1. The detailed description of the same construction as the one described above will be omitted below.

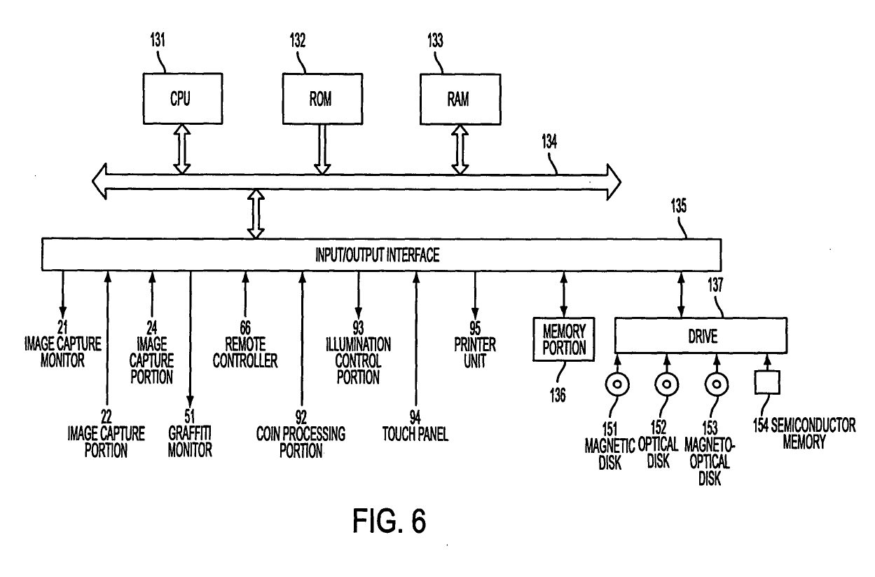

The control device 91 includes a personal computer and controls the entire operation of the photo sticker vending machine 1. More specifically, a central processing unit (CPU) 131 in the control device 91 performs processing based on programs stored in a read-only memory (ROM) 132 and/or the memory portion 136 (both in FIG. 6) including a hard disk.

When a user inserts a predetermined amount of money to the coin slot 25, a coin processing portion 92 detects and informs the payment to the control device 91. The illumination control portion 93 emits a flash of light in response to an instruction from the control device 91 when the photographic image capture portion 22 or photographic image capture portion 24 captures an image of an object. The emitted flash of light irradiates the object (that is, a user) through the transparent surfaces of the illuminating apparatus 12 in FIG. 1, which are the transparent surfaces 23-1a and 23-1b, transparent surfaces 23-2a and 23-2b, transparent surfaces 26-1a and 26-1b, and the transparent surfaces 26-2a and 26-2b.

A touch panel 94-1 and a touch panel 94-2 are stacked on the graffiti monitor 51-1 and the graffiti monitor 51-2, respectively. The touch panels 94-1 and 94-2 output instructions from a user through the input pens 53-1 and 53-2 to the control device 91.

A printer unit 95 includes a printer portion 111 and a control tag reader/writer 112 (See FIG. 5). A sticker sheet unit 96 attached to the printer unit 95 includes a sticker sheet 121 and a control tag 122. The control tag 122 manages identification information for identifying the sticker sheet unit 96.

When edited image data is received from the control device 91, the printer portion 111 prints an image expressed by the supplied image data on the sticker sheet 121 in accordance with the size and the number of divisions of the image selected by a user. Then, the printer portion 111 outputs the sticker sheet 121 to the sticker ejecting port 41.

The control tag reader/writer 112 reads out and outputs identification information stored in the control tag 122 by contact or by non-contact to the control device 91. The control device 91 determines whether or not the placed sticker sheet unit 96 is compliant with the photo sticker vending machine 1 based on the identification information supplied from the control tag reader/writer 112. Only if the control device 91 determines that the sticker sheet unit 96 is compliant, the printer portion 111 is enabled. In other words, the control device 91 manages identification information of sticker sheet units compliant with the photo sticker vending machine 1.

Thus, the use of non-genuine sticker sheets, not compliant with the photo sticker vending machine 1, is prevented The remaining amount of the sticker sheet 121 is managed by the control tag 122. Whether the sticker sheet unit 96 is genuine or not may be checked based on the barcode printed on the sticker sheet unit 96.

FIG. 6 is a block diagram showing a detailed construction example of the control device 91 in FIG. 5.

The CPU 131 performs various kinds of processing in accordance with the program stored in the ROM 132 or with the program loaded from the memory portion 136 to the random access memory (RAM) 133. The RAM 133 may also store data required by the CPU 131 for performing various kinds of processing. The RAM 133 can also store data required for implementing various kinds of processing.

The CPU 131, the ROM 132 and the RAM 133 are connected to each other through a bus 134. The bus 134 is also connected to an input/output interface 135.

The input/output interface 135 is connected to the photographic image capture monitor 21, the graffiti monitors 51-1 and 51-2 (graffiti monitors 51), the remote controller 66, the illumination control portion 93, the touch panels 94-1 and 94-2 (touch panels 94) and the printer unit 95 shown in FIG. 5.

The memory portion 136 stores programs performed by the CPU 131, data of background images to be combined with images captured by the photographic image capture portions 22 and 24 and data of captured images. In the photographic image capture processing, a predetermined number of images can be captured, and the memory portion 136 stores data of the number of images corresponding to the number of captured images.

A drive 137 is connected to the input/output interface 135 as required. A magnetic disk 151, an optical disk 152, a magneto-optical disk 153 or a semiconductor memory 154 is attached to the drive 137 as required. Then, a computer program read therefrom is stored in the memory portion 136 as required.

Next, the processing by the photo sticker vending machine 1 will be described with reference to flowcharts.

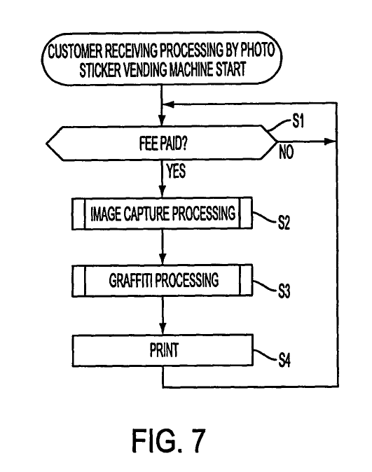

First of all, the entire processing of the photo sticker vending machine 1 for receiving a customer (user) using the photo sticker vending machine 1 will be described with reference to a flowchart in FIG. 7.

At a step S1, the CPU 131 of the control device 91 determines whether a fee is paid or not, that is, whether a user starts to capture an image or not based on the output from the coin processing portion 92. The CPU 131 waits until it determines that the fee is paid.

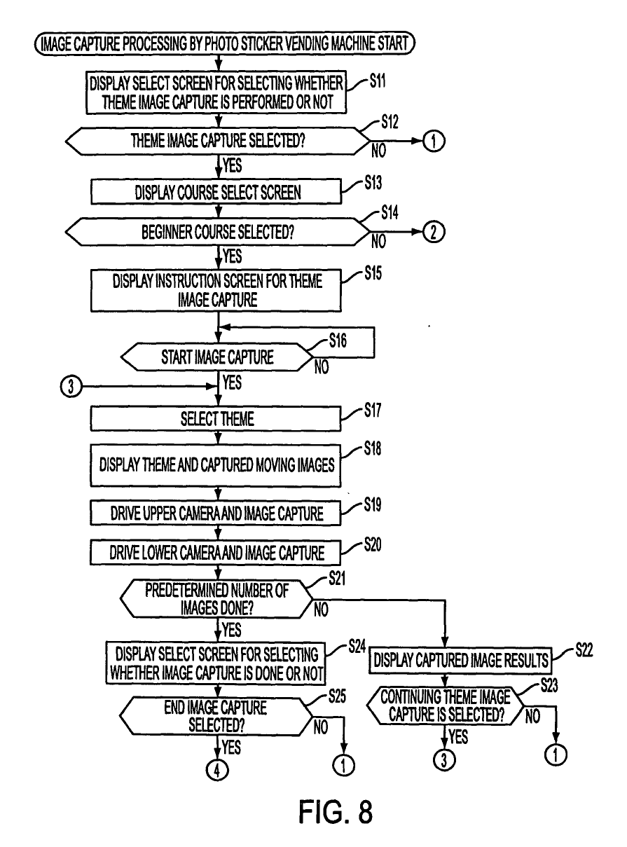

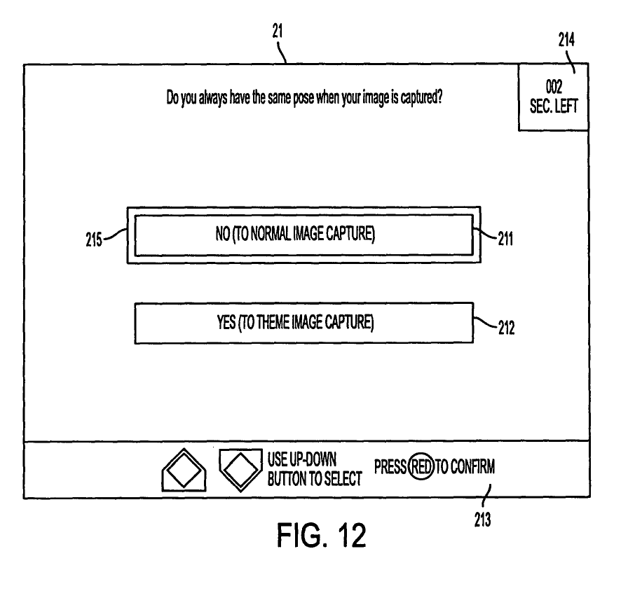

If the CPU 131 determines that the fee has been paid at the step S1, the method goes to a step S2, where photographic image capture processing in the photographic image capture space 62 is performed. In other words, a predetermined number of images are taken repeatedly. When an image to be edited is selected from the obtained images, the photographic image capture processing ends. The photographic image capture processing performed at the step S2 will be described later in detail with reference to flowcharts in FIGS. 8 to 11 and display examples of the shooting monitor 21 in FIGS. 12 to 28.

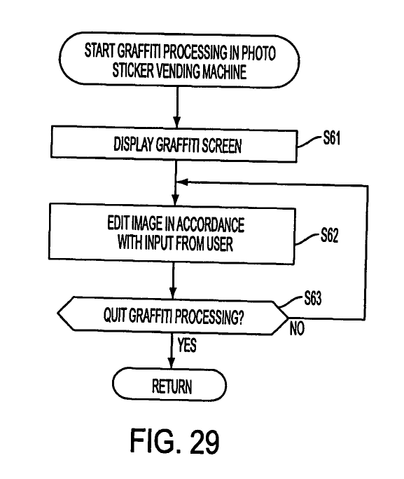

At the step S3, the CPU 131 performs graffiti processing for editing the captured image in accordance with input from the user. The editing processing performed at the step S3 will be described later in detail with reference to a flowchart in FIG. 29.

At a step S4, the CPU 131 transfers image data of the graffiti image created by the graffiti processing to the printer portion 111 of the printer unit 95 and causes the printer portion 111 to print the image. When the printing processing ends, the method goes to the step S1, and the above-described processing is performed repeatedly.

The processing shown in FIG. 7 is performed not only in a time-series manner in accordance with the described order but also in parallel in accordance with the state of use of the photo sticker vending machine 1. For example, when a second user starts the photographic image capture process in the photographic image capture space 62 immediately after a first user finishes image capture in the photographic image capture space 62 and moves to the graffiti space 73, the photographic image capture processing (processing for the second user) at the step S2 in FIG. 7 and the graffiti processing (processing for the first user) at the step S3 are performed in parallel. Similarly, the photographic image capture processing, the graffiti processing and the printing processing at a step S4 can be performed in parallel in accordance with the respective states.

Next, the detail of photographic image capture processing performed at the step S2 in FIG. 7 will be described with reference to the flowcharts in FIGS. 8 to 11.

At a step S11, the CPU 131 displays on the photographic image monitor 21 a screen for selecting whether theme image capturing is to be performed or not. Here, the term “theme image capturing” refers to a photographic image capture mode in which a “theme” conceptually representing a pose (position) and/or expression of a user to be displayed on the photographic image capture monitor 21 is displayed to a user. A user in a pose or expression associated with the theme is captured. Therefore, when performing image capture in the theme image capturing mode is selected, a user must create his/her pose and/or expression based on one theme given for each image. A theme may be displayed by text on the photographic image capture monitor 21 or may be output by voice from a speaker, not shown. A theme may be given to a user in both ways.

FIG. 12 is a diagram showing a screen example displayed at the step S11.

In the display example in FIG. 12, a message, “Do you always have the same pose when you are photographed?” is displayed on the upper part of the screen. By manipulating a button to the question, whether the theme image capturing is performed or not can be selected.

A NO button 211 and a YES button 212 are displayed substantially on the center of the screen. The NO button 211 is selected in order not to perform theme image capturing, that is, in order to perform “normal image capturing”. The YES button 212 is selected in order to perform “theme image capturing”. An instruction message is displayed in an instruction display area 213 at the bottom of the screen. The instruction message informs that the user that the up-down button on the remote controller 66 may be manipulated to select one of the NO[[-]]button 211 and YES button 212, which by using the cursor 215 and the red button may be then manipulated to select whether theme image capturing will be performed or not.

A time limit indicating area 214 is displayed at the upper right corner of the screen. The time limit indicating area 214 is indicating a remaining time “002 SEC. TO GO” for selecting whether the “theme image capturing” will be performed or not. When the time limit expires (that is, the remaining time of the time limit reaches zero, the photographic image capturing is started in the mode selected by the cursor 215 at that time.

Since not all of users may prefer photographic image capturing with a led pose, the guidance screen as shown in FIG. 12 is displayed to ask the user to select an image capture mode first. Thus, a user can select a photographic image capture mode, and a wide range of users can be satisfied. Furthermore, the message, “Do you always have the same pose when you are photographed?” meaningfully asks, a user to select one of the normal image and the theme image capturing. Thus, a user can feel an expectation and/or surprise for the subsequent unknown play. Also, a user can clearly recognize the choices so that misoperation can be prevented.

Referring back to FIG. 8, at a step S12, the CPU 131 determines whether the theme image capturing is selected or not based on the output from the remote controller 66. Since the NO button 211 is manipulated on the screen shown in FIG. 12, it is determined that theme image capturing is not selected. Then, subsequent image capturing is performed in the normal image capturing mode. In other words, the photographic image capture monitor 21 does not display a “theme”, and a user can take his/her photographs with poses or expressions the user likes. The photographic image capture shooting processing in the normal image capture mode will be described later.

On the other hand, if the CPU 131 determines at the step S12 that the theme image capturing is selected, that is, if CPU 131 determines that the YES button 212 is manipulated on the screen shown in FIG. 12, the processing goes to step S13. At step S13, a course select screen is displayed on the photographic image capture monitor 21. The course select screen is used by a user for selecting a course in accordance with the degree of skill.

In this example, the instruction screen for instructing the user regarding the steps of the “theme image capturing” appear first. Then, three courses of “beginner course”, “intermediate course” and “advanced course” are provided. In the “beginner” course, theme image capturing is started. In the “intermediate course”, a “theme” randomly and automatically selected by the photo sticker vending machine is presented to a user, and the user is photographed based on the theme. In the “advanced course”, a user can specify a “theme”, and the user is shot based on the specified theme.

Therefore, a user can perform theme image capturing by selecting a preferred course in accordance with the degree of his/her skill.

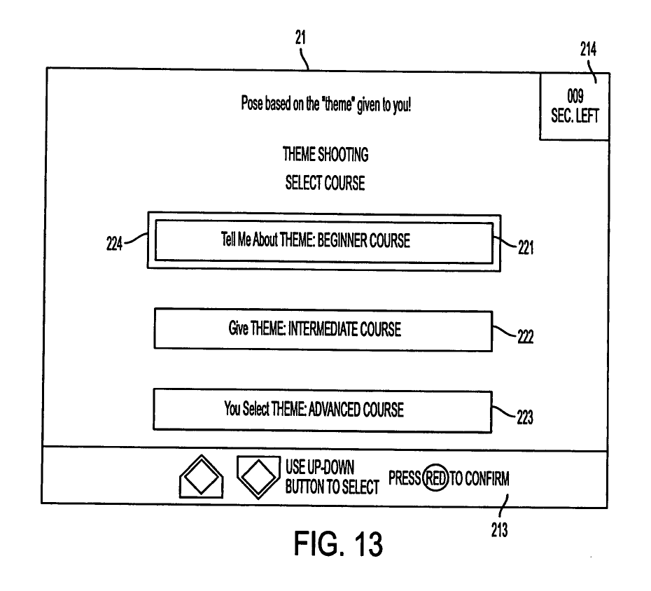

FIG. 13 is a diagram showing a display example of a course selecting screen in the theme image capturing.

In the example shown in FIG. 13, a message, “Pose based on the “theme” given to you!” is displayed on the upper part of the screen for prompting a user to pose for image capturing based on the given theme. A beginner course button 221, intermediate course button 222 and advanced course button 223 are displayed under the message. The beginner course button 221 is manipulated for selecting the “beginner course”. The intermediate course button 222 is manipulated for selecting the “intermediate course”. The advanced course button 223 is manipulated for selecting the “advanced course”.

A user moves the cursor 224 in accordance with the instruction displayed on the instruction display area 213 and selects a course in accordance with the degree of his/her skill.

In FIG. 13, the beginner course button 221 has a description, “Tell Me About THEME” thereon. The intermediate course button 222 has a description, “Give THEME” thereon. The advanced course button 223 has a description “You Select THEME” thereon. The remaining time limit set for selecting one of the courses is “009 sec” as described in the instruction display area 213.

At a step S14, the CPU 131 determines whether the beginner course is selected or not, that is, whether the beginner course button 221 is manipulated on the screen shown in FIG. 13. If the CPU 131 determines that the beginner course is selected, the processing goes to a step S15, where an instruction screen for the theme image capturing is displayed.

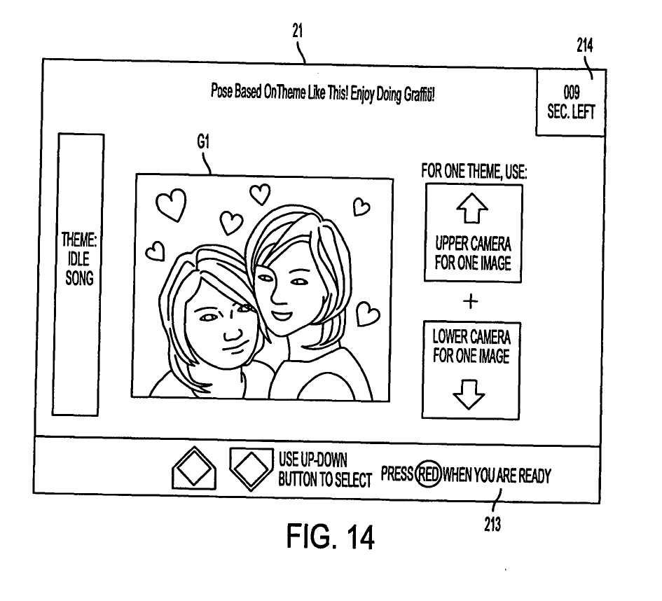

FIG. 14 is a diagram showing a screen example to be displayed at the step S15.

In the screen example shown in FIG. 14, a message, “Pose Based On Theme Like This! Enjoy Doing Graffiti!” is displayed on the upper part of the screen. A sample image G1 is displayed under the message as an example of an image captured in the theme image capture mode. A theme, “IDLE SONG” is displayed on the immediate left side of the sample image G1. The captured sample image G1 has an object having a pose and/or expression associated with the theme, “IDLE SONG”.

Multiple hard figures are displayed on the sample image G1. These are an example of graffiti images, which can be input after shooting.

In the example in FIG. 14, a fact that an upper camera (CCD 22A) and lower camera (CCD 24A) are used for shooting for one theme is described on the immediate right side of the sample image G1. Therefore, a user can capture his/her pose and/or expression associated with one theme twice from different angles.

As described above, when the “beginner course” is selected, the instructions for the theme image capturing are displayed. Thus, even a user who uses the photo sticker vending machine 1 for a first time can perform photographic image capturing without being bewildered by a given theme.

Since a sample image corresponding to a given theme is displayed, a sample pose can be visually displayed to a user. Furthermore, since not only an image but also text describing a given “theme” are displayed, which prompts a user to understand the essential meaning of the theme with which the sample image is associated. Thus, the creativity of the user can be tickled.

At a step S16, the CPU 131 determines whether photographic image capture is started or not and keeps displaying an instruction screen of the theme image capture until the CPU 131 determines that image capture is instructed to start. For example, the instruction display area 213 in FIG. 14 displays an instruction to manipulate the red button on the remote controller 66 in order to start image capturing. At a step S16, the CPU 131 determines that image capturing is instructed to start when the red button is manipulated or when a time limit for the display of the instruction screen expires (the remaining time is “009 sec.” in the time limit indicating area 214 in FIG. 14. Then, the processing goes to a step S17, where a theme is selected.

For example, one theme is selected from multiple pre-registered themes. At a step S18, the selected theme and shooting screen displaying moving images (real view) being captured by the CCD 22A are displayed on the photographic image capture monitor 21. The moving images (real view) being captured by the CCD 22A are also displayed on the image display portion 22A near the CCD 22A.

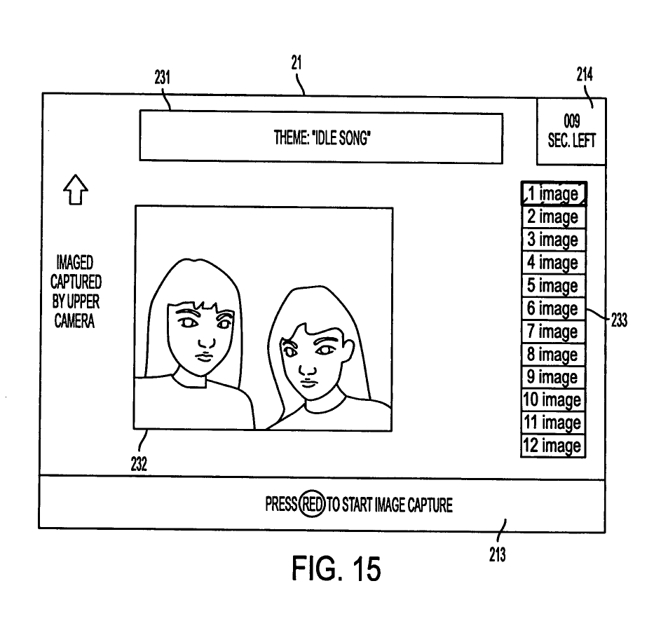

FIG. 15 is a diagram showing an example of a photographic image capture screen displayed at the step S18.

The theme (“IDLE SONG”) selected at the step S17 is displayed on a theme indicating area 231 set at the upper part of the image capturing screen. Moving images of an object (two users) being captured by the CCD 22A are displayed on an image display area 232 set under the theme indicating area 231.

Therefore, in this example, the two users create poses and/or expressions associated with the theme “IDLE SONG” indicated on the theme indicating area 231. Then, the users perform image capture with the poses and/or expressions. In order to shoot a group of people, the poses and/expressions associated with a given theme may be discussed. Thus, each of the users can feel a sense of solidarity when their images are captured in group. In other words, the supply of a theme can provide an opportunity for encouraging better communication. Thus, more interesting image capturing can be expected.

A fact that image capturing from the CCD 22A (upper camera) has ended, is indicated on the immediate left side of the image display area 232. The display is switched when the image capturing by the CCD 22A ends, and a fact that image capturing by CCD 24A will be performed is indicated.

A number-of-shots indicating area 233 displayed on the right side of the photographic image capture screen indicates the number of images captured until the current image. In the example in FIG. 15, the maximum of twelve image captures can be performed in the entire image capture processing. The first image capture among them flashes (which is shaded in FIG. 15).

A fact that the red button on the remote controller 66 can be manipulated to start shooting is indicated on the instruction indication area 213. The remaining time of the time limit set for shooting is “009 sec.” here.

For example, when the red button on the remote controller 66 is manipulated to instruct start image capturing, or when the remaining time reaches zero second, the CPU 131 controls the CCD 22A (upper camera) to capture an image at a step S19.

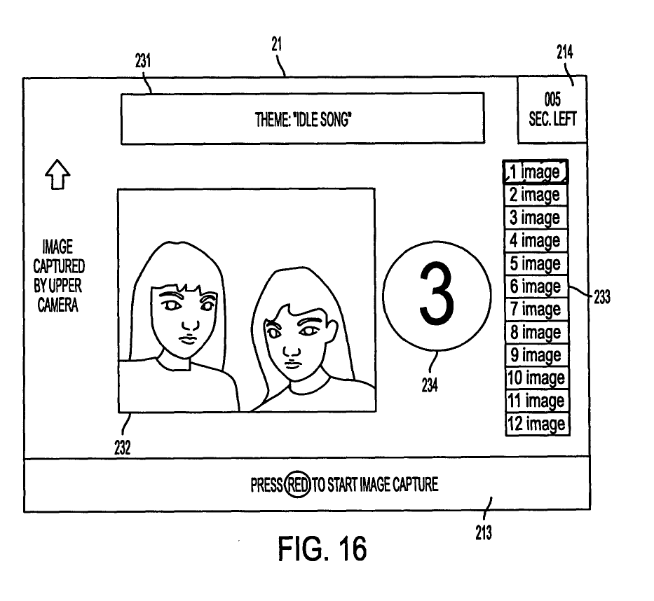

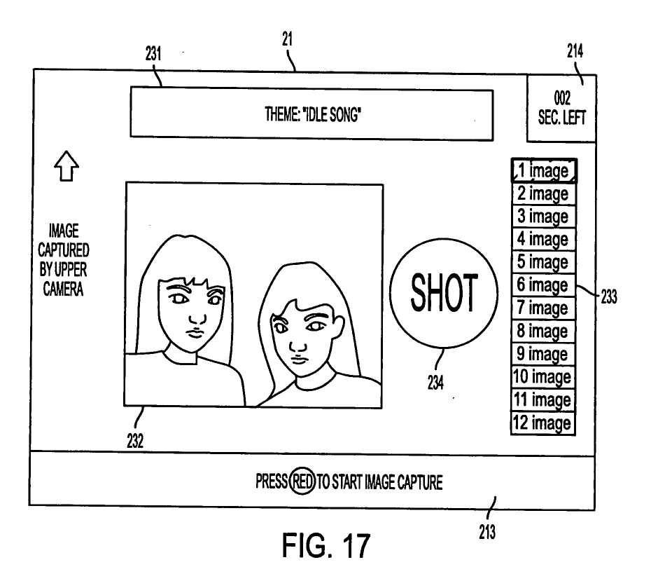

For example, immediately before capturing an image, a count-down image 234 indicating counts such as “5, 4, 3, 2 and 1” is displayed between the image display area 232 and number-of-images indicating area 233 as shown in FIG. 16. When the indication is “0 (zero)”, image capturing is performed. When image capturing is performed, the countdown image 234 is replaced by an image having a word, “image”, at the center, as shown in FIG. 17. The image and resulting image data is stored in the RAM 133 or storage portion 136.

After the image processing is performed by the CCD 22A at the step S19, the processing goes to a step S20, where the CPU 131 causes the CCD 24A (lower camera) to capture an image. In other words, an image displayed on the image display area 232 on the photographic image capture screen shown in FIG. 15 is replaced by moving images being captured by the CCD 24A. Furthermore, the indication of the camera image capture next, which is displayed on the left side of the screen, is replaced by a message, “Your Image Will Be Captured By Camera Below”, informing that the CCD 24A will capture and image. Since the CCD 22A and CCD 24A (upper and lower cameras) are used for capturing images for one theme, the theme, “IDLE SONG” is displayed on the theme indicating area 231, like FIG. 15.

After the countdown image 234 is displayed and the image of the object is captured by the CCD 24A, the CPU 131 determines whether a predetermined number of images or more are performed or not at a step S21. For example, after six images in total by both of the CCD 22A and 24A, the user can finish the image capture processing without further subsequent captured images. In this case, each image captured by the CCD 22A is counted as one image, and each image captured by the CCD 22A is also counted as one image.

If the CPU 131 determines at a step S21 that no more images than a predetermined number of images are captured, the processing goes to a step S22, where the images resulting from the images captured by the CCD 22A and CCD 24A are displayed on the photographic image capture monitor 21.

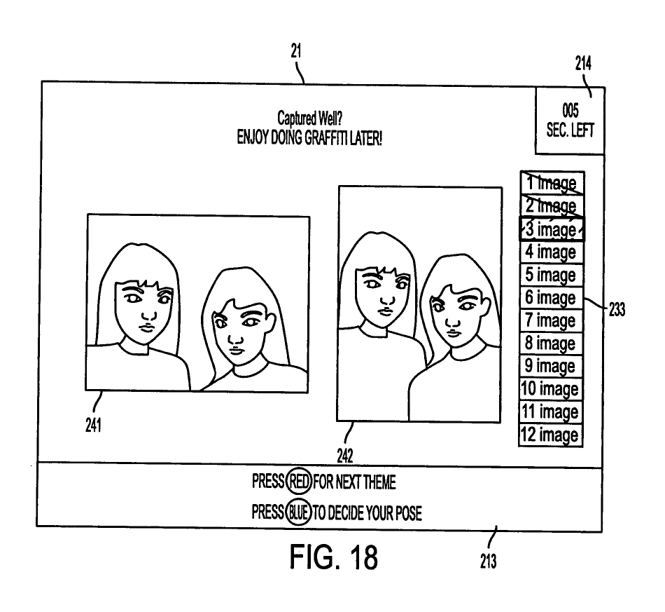

FIG. 18 is a diagram showing a screen example to be displayed at the step S22.

In the display example shown in FIG. 18, a message, “Taken Well? Enjoy Doing Graffiti Later!” is also displayed on the upper part of the screen. Images resulting from the image capture are displayed immediately under the message. For example, images captured by the CCD 22A are displayed on the image display area 241 while images captured by the CCD 24A are displayed on the image display area 242 on the right of the image display area 241.

The screen shown in FIG. 18 is a display example immediately after two images (images by the CCD 22A and CCD 24A for a first theme). On the number-of-images indicating area 233, the image (1 SHOT) indicating a first images and the image (2 SHOT) indicating a second image have one diagonal lines thereon, respectively, which mean that these images have been already finished. The next image (3 SHOT) flashes (which is shaded in FIG. 18) for indicating that the next image captured is a third image.

On the screen displaying image results, a user can select either to continue theme image capture or to finish theme image capture and continue image capture in the normal image capture mode. The instruction for the choices is displayed on the instruction display area 213. On the instruction display area 213 in FIG. 18, the instruction informs a user that the user can continue the theme image capture by manipulating the red button on the remote controller 66 and that the user can finish the theme shooting and continue image capture in the normal image capture mode by manipulating the blue button.

At a step S23, the CPU 131 determines whether the theme image capture is instructed to continue or not. If the CPU 131 determines that the image capture in the normal image capture mode is instructed to continue, that is, the theme image capture is not instructed to continue since the blue button on the remote controller 66 has not been operated, the image capture continues in the normal image capture mode in a manner described later. On the other hand, if the CPU 131 determines that the theme image capture is instructed to continue since the red button on the remote controller 66 is manipulated for the screen displaying the image capture results, the processing returns to the step S17. Then, the step S17 and subsequent steps are performed.

In other words, a theme different from the themes having been given until then is selected for each image by the CCD 22A and CCD 24A and is presented to a user. The user repeatedly captures himself/herself with poses and/or expressions associated with given themes.

At the step S21, if the CPU 131 determines that a predetermined number of images or more have been captured, the processing goes to a step S24. At the step S24, the image result of the image capture performed immediately before is displayed, and a selecting screen for selecting whether the image capture is finished or not is displayed on the photographic image capture monitor 21.

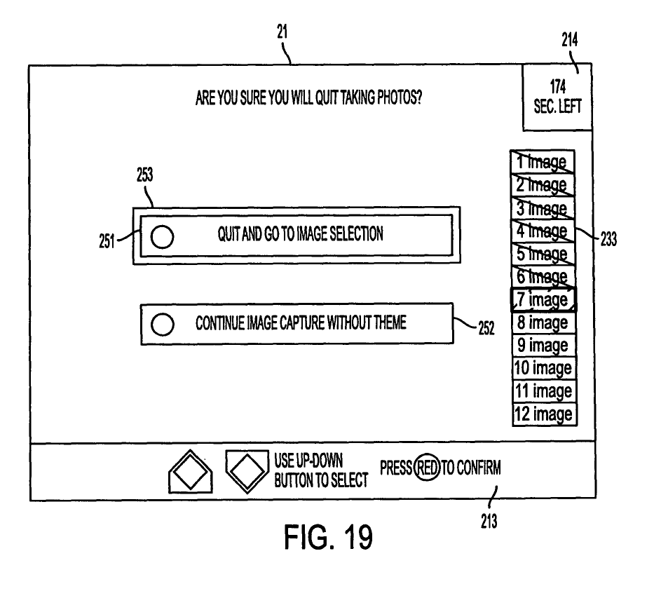

FIG. 19 is a diagram showing an example of a selecting screen to be displayed at the step S24.

In the display example in FIG. 19, a message, “Are You Sure You Will Quit Taking Photos?” is displayed on the upper part of the screen. Choice buttons 251 and 252 are displayed under the message. The choice button 251 is manipulated to finish the image capture and to go to an operation for selecting an image to do graffiti. The choice button 252 is manipulated to continue image capture in the normal image capture mode.

An instruction for choosing either the choice button 251 or the choice button 252 is displayed on the instruction display area 213. A user moves the cursor 253 by manipulating the remote controller 66 by following the instruction and manipulates one of the choice buttons 251 and 252. The number-of-images indicating area 233 indicates that the image on the screen shown in FIG. 19 is displayed immediately after the end of the sixth shot. The time limit indicating area 214 indicates that the remaining time of the image is “174 sec.”

The CPU 131 determines at step S25 whether the end of the image capture is selected or not. If the CPU 131 determines that the image capture in the normal image capture mode is selected since the choice button 252 in FIG. 19 has been manipulated, the image capture is continued in the normal image capture mode as described later. On the other hand, if the CPU 131 determines at the step S25 that the end of the image capture is selected since the choice button 251 was manipulated, the processing goes to a step S26 where a screen for selecting an image is displayed such that the CPU 131 can prompt the user to select an image to do graffiti.

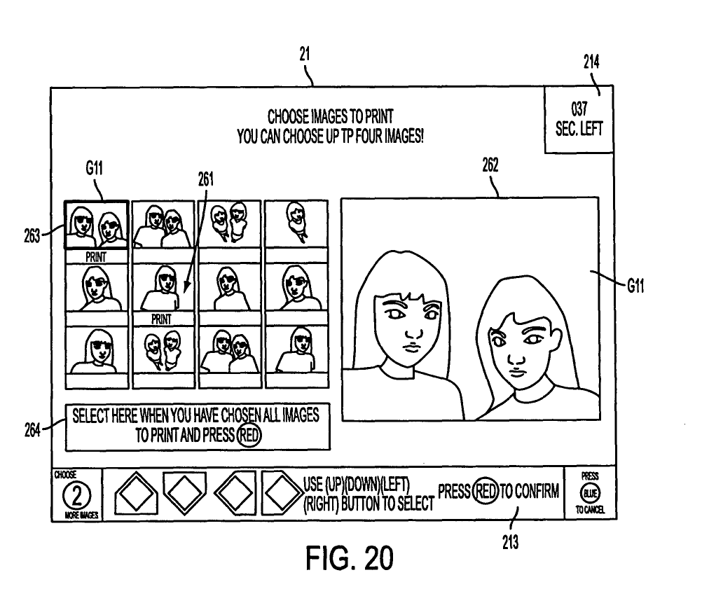

FIG. 20 is a diagram showing a screen example displayed at the step S26.

On the screen shown in FIG. 20, a user can enlarge a preferred one of a list of images (thumbnail images) and can adjust the brightness of the enlarged image.

For example, a list display area 261 substantially on the left half of the screen displays a list of images stored in the normal image capture mode. The enlarged-image display area 262 on the right half of the screen displays an enlarged image selected from the list of images by the cursor 263.

In the example in FIG. 20, an image G11 displayed on the upper left of the list display area 261 is selected, and the image G11 is enlarged in the enlarged-image display area 262.

The user moves the cursor 263 vertically and/or horizontally by manipulating the remote controller 66 by following the instruction displayed on the instruction display area 213 in order to switch the image displayed in the enlarged-image display area 262. The instruction display area 213 displays an instruction for selecting an image (enlarged image on the enlarged-image display area 262) selected by the cursor 263 for adjusting the brightness.

After the user repeatedly selects images and adjusts the brightness, the user selects, by using the cursor 263, a select end button 264 having a message, “Select Here When You Have determined All and Press the Red Button!” under the list display area 261. Then, the user can manipulate the red button on the remote controller 66 so as to finish the image selection.

When a user adjusts the brightness and selects one image to do graffiti, information indicating the image was selected (called selected-image information hereinafter) is added to the image displayed in the list display area 261. In the example in FIG. 20, a description, “Make Sticker” as the selected-image information is added immediately under an image displayed on the upper left part of the list display area 261 and an image displayed on the lower right part of the image.

As the selected-image information, a predetermined figure such as a star shape indicating that the image has been checked may be displayed on the image or a predetermined color may be added to the entire image. Since the sleeted-image information is added to the image selected as an image to do graffiti, a user can intuitively recognize the selected image.

The image having the adjusted brightness is displayed with the adjusted brightness on the list display area 261.

A theme (having been given for image capture) of an image selected from the thumbnail images may be displayed near the enlarged image on the screen for selecting an image for graffiti as shown in FIG. 20. Thus, a user can again compare his/her image pose and the theme and can remember the condition of the image. Thus, the user can come more alive.

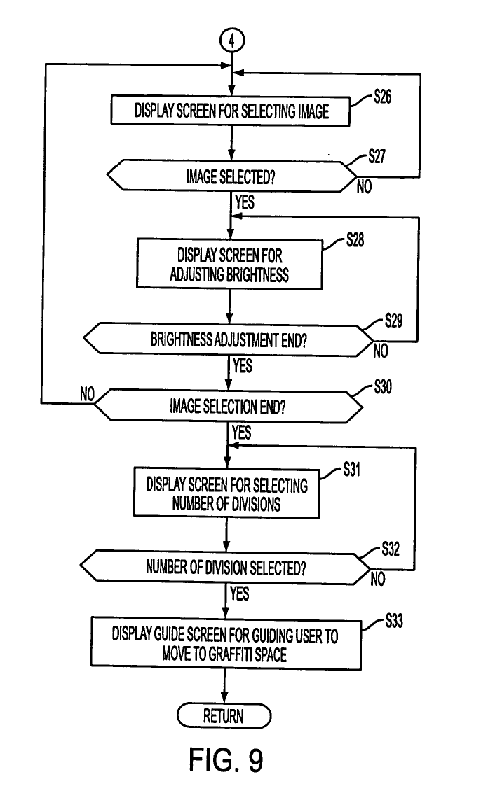

Referring back to FIG. 9, the CPU 131 determines at a step S27 whether an image to adjust the brightness is selected or not from the images displayed on the list display area 261 based on the output from the remote controller 66. If the CPU 131 determines that an image is selected, the processing goes to a step S28.

At the step S28, the CPU 131 causes the photographic image capture monitor 21 to display an adjustment screen for adjusting the brightness of the image selected on the screen shown in FIG. 20.

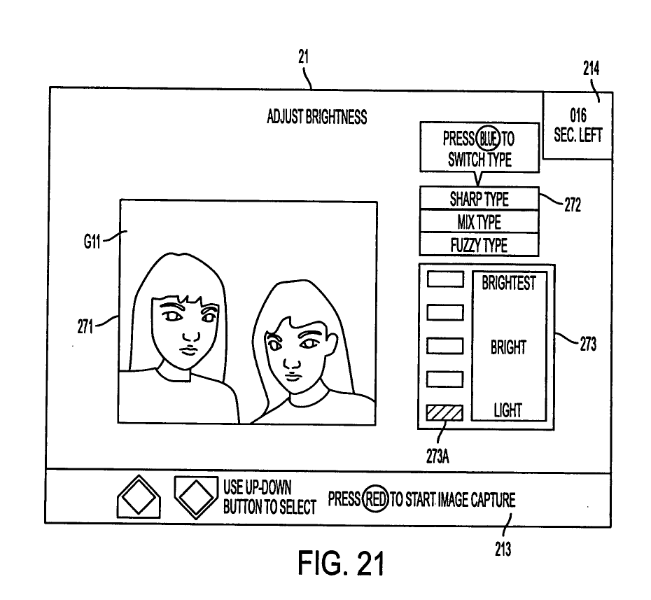

FIG. 21 is a diagram showing a display example of the screen for adjusting the brightness.

In FIG. 21, a message, “Adjust Brightness” is displayed on the upper part of the screen. The image G11 selected on the selecting screen in FIG. 20 is displayed on the image display area 271 under the message as an image to adjust the brightness.

A user can select one of “Sharp Type”, “Fuzzy Type” and “Mix Type”. The “Sharp Type” is selected for correcting the contours displayed on a contour selecting area 272 to be more emphasized. The “Fuzzy Type” is for blurring away a contour. The “Mix Type” corrects a contour with a medium level between the “Sharp Type” and “Fuzzy Type”.

A brightness adjusting area 273 is displayed immediately under the contour selecting area 272. In the example shown in FIG. 21, one of five levels of brightness can be selected. A user vertically moves the position of a select bar 273A by using the up-down button on the remote controller in accordance with the instruction displayed in the instruction display area 213 in order to adjust the brightness (or intensity) of the image displayed in the image display area 271. For the intuitive identification of the levels of brightness, descriptions, “BRIGHTEST”, “BRIGHT” and “LIGHT” are displayed by corresponding to the levels of brightness, respectively. The time limit indicating area 214 indicates that the remaining time of the brightness adjustment is “016 sec.”

Referring back to FIG. 9, the CPU 131 determines at a step S29 whether the brightness adjustment for the image has ended or not. If the CPU 131 determines that the brightness adjustment has not ended yet, the processing returns to the step S28 where the adjustment screen is continuously displayed.

On the other hand, If the CPU 131 determines at the step S29, that the bright ness adjustment has ended, the processing goes to a step S30 where the CPU 131 determines whether the image selection has ended or not. In other words, when the brightness of one image is adjusted on the adjustment screen shown in FIG. 21, the screen on the photographic image capture monitor 21 is replaced by the selecting screen shown in FIG. 20. After the repetitive multiple number of times of adjustment, the select end button 264 can be pressed. Therefore, when the select end button 264 is pressed, or when a preset time limit expires, the CPU 131 determines that the image selection has ended.

When the CPU 131 determines at a step S30 that the image selection has ended, the processing goes to a step S31 where a number-of-division selecting screen is displayed. On the number-of-division selecting screen, the number and size of images to be printed on one sticker sheet 121 are selected.

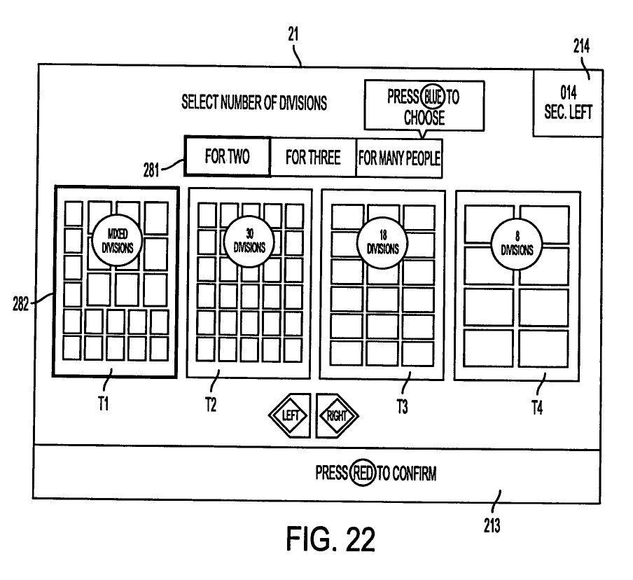

FIG. 22 is a diagram showing a display example of the number-of-division selecting screen to be displayed at a step S31.

In the example shown in FIG. 22, a message, “Select The Number Of Divisions” is displayed on the upper part of the screen. Sticker sheet images T1 to T4 in line representing types of the number of divisions are displayed substantially at the center of the screen.

A user manipulates the left-right button on the remote controller 66 by following an instruction displayed on the instruction display area 213 and selects his/her preferred number of divisions through the cursor 282 responsive to the manipulation. As shown in FIG. 22, for example, “Mixed Divisions”, “30 Divisions”, “18 Divisions” and “Eight Division” are prepared. When the “Mixed Divisions” is selected, images in two sizes are printed on one sticker sheet 121. When the “30 Divisions” is selected, the total of 30 images in one size is printed on one sticker sheet 121. When the “18 Divisions” is selected, the total of 18 images in one size is printed on one sticker sheet 121. When the “8 Divisions” is selected, the total of 8 images in one size is printed on one sticker sheet 121. Similarly, for printing larger images on the sticker sheet 121, the number of divisions such as “2 Divisions” and/or “4 Divisions” may be selected.

The number-of-division pattern may be changed among the images T1 to T4 in accordance with the number of people in a shooting group. In the example shown in FIG. 22, the display of the images T1 to T4 is changed among “For Two”, “For Three” and “For Many People” in accordance with the number of people selected by the cursor 281.

The CPU 131 determines at a step S32 whether the selection of the number of divisions has ended or not. The processing returns to the step S31 where the screen for selecting the number of divisions is continuously displayed until the CPU 131 determines the end of the selection of the number of divisions. For example, when the red button on the remote controller 66 is manipulated on the screen shown in FIG. 22, or when a predetermined time limit expires, the CPU 131 determines at the step S32 that the selection of the number of divisions has ended. Then, the processing goes to a step S33 where a guide screen for guiding a user to move to the graffiti space 73 is displayed on the photographic image capture monitor 21.

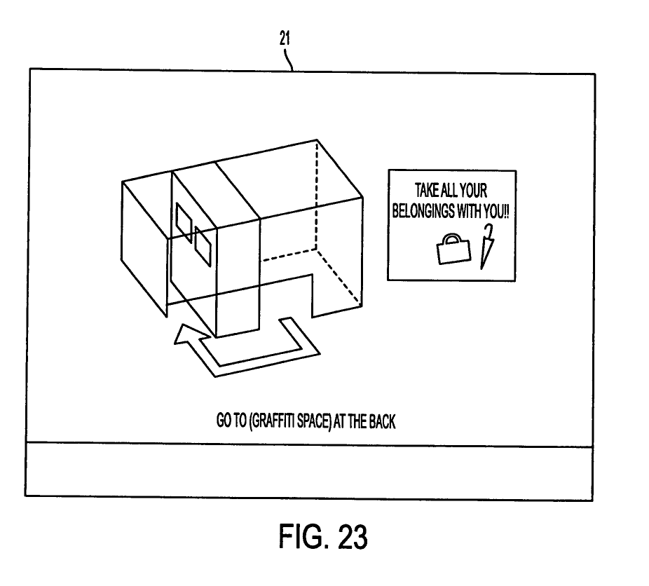

FIG. 23 is a diagram showing a display example of the guide screen to be displayed at the step S33.

For example, on the guide screen, a perspective image showing the cabinet 11, the surroundings and an image for guiding a user to move to the graffiti space 73 through the front of the left side 11c as indicated by an open arrow. Furthermore, in the example in FIG. 23, a message, “Move To Graffiti Space At The Back”, is displayed at the bottom of the screen. A message, “Attention! Take All Your Belongings With You”, is displayed on the right of the screen.

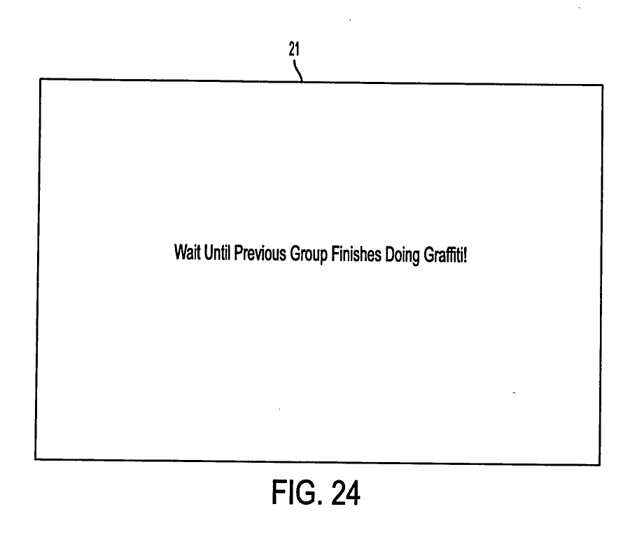

When another user group which finished their image capture processing and which has used the photo sticker vending machine 1 are still doing graffiti on images in the graffiti space 73 (or when the graffiti space 73 is not vacant), a message such as “Wait Until The Previous Group Finishes Doing Graffiti” as shown in FIG. 24 is displayed.

After that, a user having finished his/her photographic image capture shooting processing moves to the graffiti space 73 and does graffiti on an image selected from captured images.

When the “Beginner Course” is selected on the course selecting screen displayed at the step S13, the image capture processing advances as described above. On the other hand, when the “Beginner Course” is selected on the course selecting screen, and when the CPU 131 determines at the step S14 that the “Beginner Course” has not been selected, the processing goes to a step S34. At the step S34, the CPU 131 determines whether the implementation of theme image capture for the “Intermediate Course” has been selected or not.

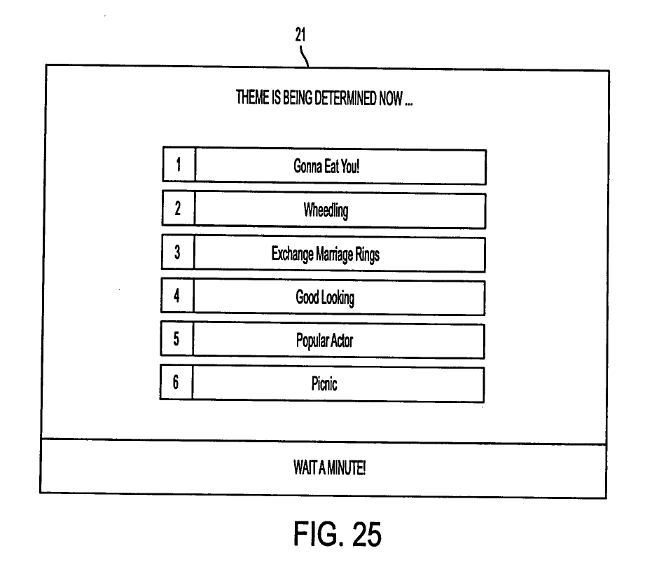

When the CPU 131 determines at the step S34 that the intermediate course button 222 (FIG. 13) was manipulated and the implementation of theme image capture for the Intermediate Course has been selected, the processing goes to a step S35. At the step S35, a predetermined theme is selected from pre-registered themes based on randomly created random numbers. Then, the selected theme is given to a user on the display screen as shown in FIG. 25.

A message, “Theme is Being Determined Now”, is displayed on the upper part of the screen shown in FIG. 25. Randomly selected six different themes are displayed under the message. For example, themes are sequentially selected from a first theme (the theme displayed at the top) and are displayed at respective fields. The displays in the fields such as the displays of multiple themes are changed fast. Then, one theme selected from them finally stops and is displayed.

In the example in FIG. 25, “Gonna Eat You!”, “Wheedling”, “Exchange Marriage Rings”, “Good Looking”, “Popular Actor” and “Picnic” are displayed as first to sixth themes, respectively.

In this way, when multiple different themes can be selected from different genres, a user has a hard time thinking about the pose and/or expression suitable for a given theme. Therefore, a game characteristic is given to the image capture itself. A user may select a predetermined genre, and a randomly selected theme in the genre may be given to the user.

When the theme selection ends (or when the display of the sixth theme ends on the display screen in FIG. 25), the processing goes to a step S36. At the step S36, the CPU 131 displays a predetermined theme of the theme in accordance with the number of images at that time is displayed, and the image capture starts.

In other words, when the theme shown in FIG. 25 is selected, the theme, “Gonna Eat You!” is displayed at the first image (by the CCD 22A and 24A). Thus, a user captures an image of himself/herself with a pose and/or expression associated with the theme. Like the case of the “Beginner Course”, image capture by the CCD 22A is performed at a step S37 first. Then, image capture by the CCD 24A is performed at a step S38.

The image capture screen is similar to the screen shown in FIG. 15, and one of randomly selected themes is displayed in the theme display area 231. The countdown image 234 (FIG. 16) is displayed immediately before the image capture, and the countdown image 234 (FIG. 17) is displayed when image capture is started.

At a step S39, the CPU 131 determines whether a predetermined number of images (such as six images) or more have been performed or not. If not, the processing goes to a step S40, and the image resulting from the image capture is displayed on the same screen as shown in FIG. 18.

At a step S41, the CPU 131 determines whether the theme image capture has been instructed to continue or not. When the blue button on the remote controller is manipulated for the screen in FIG. 18 displaying the image capture result, the CPU 131 determines that the image capture in the normal image capture mode has been instructed to continue. Then, the image capture in the normal image capture mode continues. On the other hand, when the red button on the remote controller 66 is manipulated, the CPU 131 determines that the theme image capture is instructed to continue. Then, the processing returns to the step S36, and the step S36 and subsequent steps are repeated.

In other words, when the six kinds of theme shown in FIG. 25 are selected, “Wheedling” selected as the second theme is displayed after the first theme. Then, a user captures an image of himself/herself with the pose and/or expression associated with the theme.

Subsequently, “Exchange Marriage Rings”, “Good Looking”, “Popular Actor” and “Picnic” selected as the third to sixth themes, respectively, are sequentially displayed in accordance with the current number of times of images. Then, a user captures an image of himself/herself with the poses and/or expressions associated with the themes.

If the CPU 131 determines at the step S39 that a predetermined number of times of images and more have been performed, the processing goes to a step S42 where the image capture monitor 21 displays the selecting screen shown in FIG. 19. When the select button 252 in FIG. 19 has not been manipulated, the CPU 131 determines at a step S43 that the continuing of the image capture in the normal image capture mode has been selected. Then, the image capture in the normal image capture mode continues. On the other hand, when the select button 251 has not been manipulated, the CPU 131 determines that the end of the image capture has been selected. Then, the processing goes to the step S26 where a select screen for selecting an image to do graffiti is displayed.

After that, like the case of the “Beginner Course”, a predetermined number of images to do graffiti and the number of divisions of the sticker sheet 121.

On the other hand, when the “Advanced Course” is selected on the course selecting screen shown in FIG. 13, the CPU determines at the step S34 that the advance of the theme image capture for the “Intermediate Course” has not been selected. Then, the processing goes to a step S44 where the photographic image capture monitor 21 displays a theme selecting screen prepared for the “Advanced Course”.

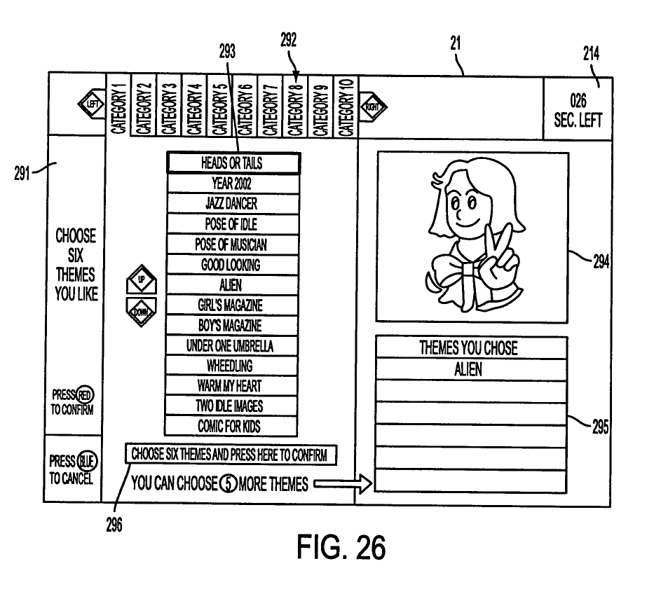

FIG. 26 is a diagram showing an example of a select screen to be displayed for selecting the “Advanced Course”. As described above, when the theme image capture for the “Advanced Course” is selected, a user can select preferred one of pre-registered themes.

For example, category tabs 292 for selecting the category of themes are displayed on the upper left part of the select screen. Registered themes are managed in category. A user selects a preferred category tab from ten categories and selects a theme used for shooting from a list of themes to be displayed by using the cursor 293.

The words, “Left” and “Right”, on the left and right of the category tabs 292 in the example in FIG. 26 indicate that the category to be selected can be changed in connection with the manipulation of the left-right button on the remote controller 66. The words, “Up” and “Down”, immediately on the left of the list of themes indicate that the theme selected by the cursor 293 can be changed in connection with the up-down button. In the example in FIG. 26, the first category is selected, and the list of themes belonging to the category is displayed.

A sample image display area 294 is provided on the right of the list of themes. The sample image display area 294 displays a sample image in which a user having a pose and/or expression associated with a given theme is captured. Since the sample image is changed for each given theme, a user can refer to the pose and/or expression in the sample image for a given theme.

An instruction in an instruction display area 291 indicates that the theme selected by the cursor 293 is determined as a theme to be used for image capture when the red button on the remote controller 66 is manipulated. A theme selected by following the instruction is displayed on a determined theme display area 295. In the example in FIG. 26, a theme, “Alien” has been selected as a first theme to be used. A message, “You Can Select Five More Themes” is displayed on the lower part of the screen. In this case, the maximum of six different themes can be selected.

When six different themes has been selected, a select end button 296 displayed immediately under the list of themes can be selected by using the cursor 293. When the select end button 296 is selected by the cursor 293 and the red button on the remote controller 66 is then manipulated, the theme selection ends.

In this way, a theme can be selected freely. Thus, an opportunity to discuss which theme they are going to use can be provided to a group of people. Therefore, more interesting image capture requiring communication in a group can be provided.

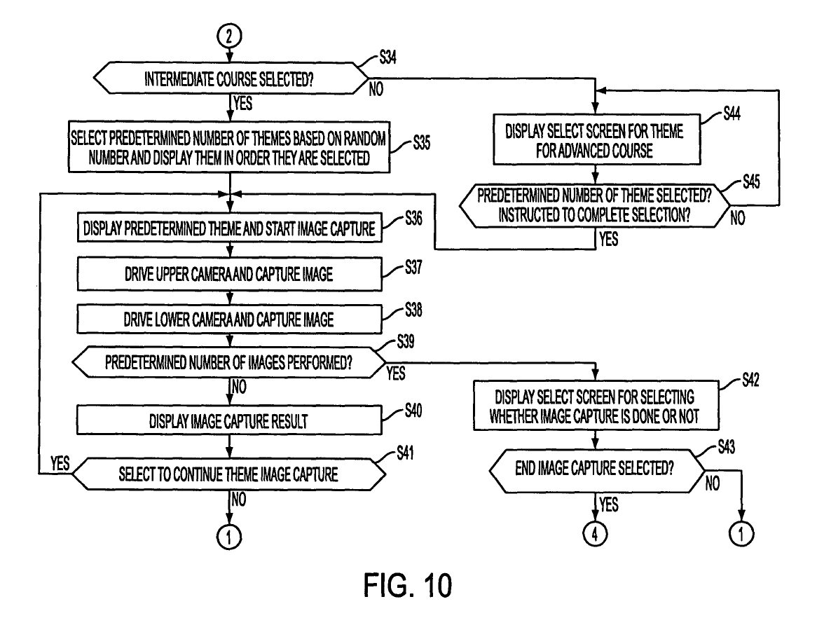

Referring back to FIG. 10, the CPU 131 determines at a step S45 whether a predetermined number of themes have been selected and the end of the selection has been instructed or not. If the CPU 131 determines that the end of the selection has not been instructed, the processing returns to the step S44 where the select screen is continuously displayed. On the other hand, if the CPU 131 determines that the end of the theme selection has been instructed, the processing goes to the step S36 where theme image capture for the “Advanced Course” is started.

In other words, the same processing as that of the theme image capture for the “Intermediate Course” is implemented, and the themes selected on the select screen in FIG. 26 are sequentially displayed on the theme display area 231 on the screen. Then, image capture by the CCD 22A and CCD 24A are performed.

After a predetermined number of times of image capture have been performed and the end of image capture has been instructed, an image to do graffiti and a number of divisions of a sticker sheet are selected. When the selection ends, the image capture processing ends.

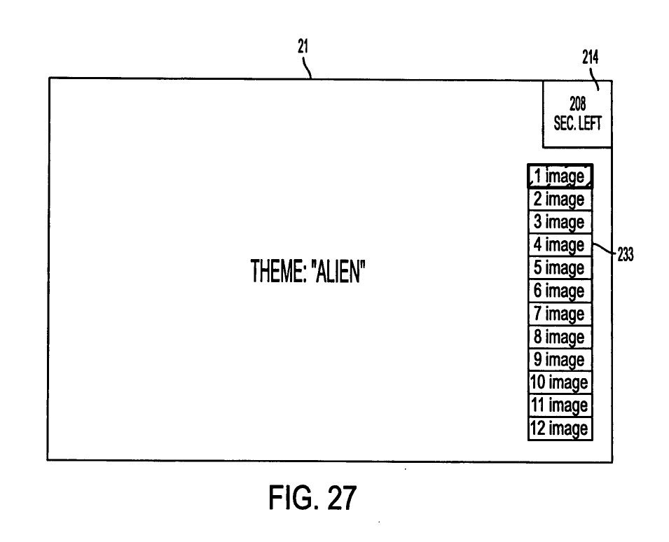

In the description above, a theme is displayed on the theme display area 231 on the image capture screen. However, for example, as shown in FIG. 27, a theme (such as “Alien”) may be only displayed at the center of the screen for a short period of time. Then, the image capture screen may be displayed. Thus, a user can more securely check the theme to be used for the next image capture. Themes can be given to a user by text displayed on the theme display area 231, a still image or moving images or voice.

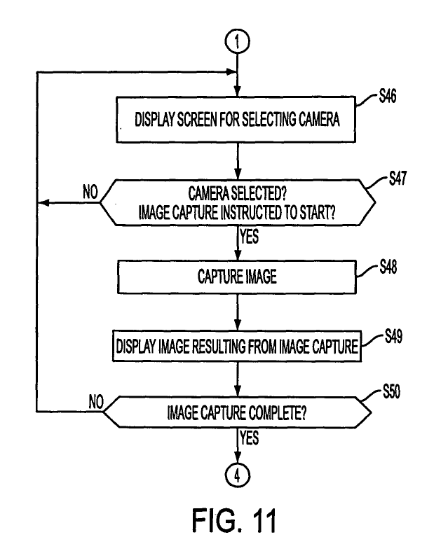

Next, the processing at the steps S12, S23, S25, S41 and S43 when image capture in the normal image capture mode is selected will be described. For example, at the step S12, the normal image capture mode for image capture with preferred poses and expressions is selected, the CPU 131 displays a screen for selecting a camera (CCD 22A or CCD 24A) on the photographic image capture monitor 21 at the step S46 in FIG. 11.

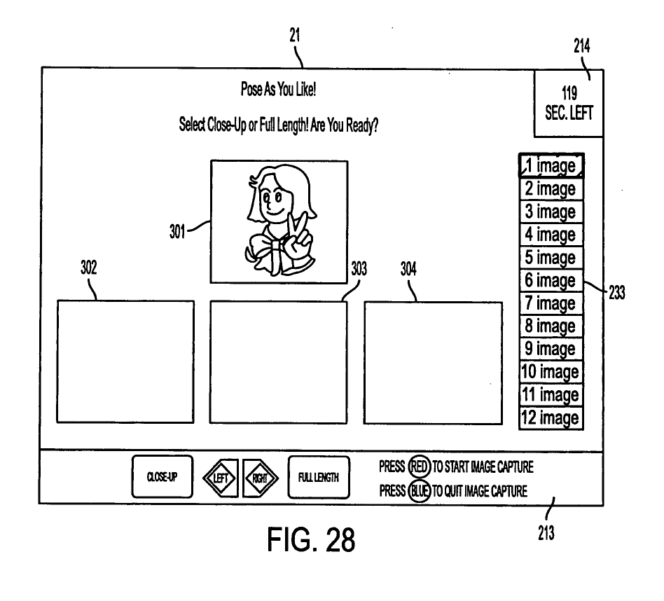

FIG. 28 is a diagram showing an example of the select screen to be displayed at the step S46.

A message, “Pose As You Like! Select Close-Up Or Full Length! Are You Ready?” is displayed on the upper part of the select screen in FIG. 28. A sample image display area 301 under the message displays a sample image of an image to be captured by the currently selected camera. In other words, when a user manipulates the remote controller 66 by following an instruction displayed on the instruction display area 213 to switch a camera for image capture, the image to be displayed on the same image display area 301 can be switched.

Therefore, a user can check the image displayed on the sample image display area 301 and capture an image by using his/her preferred camera.

An instruction on the instruction display area 213 indicates that the left-right button on the remote controller 66 is available for selecting either the CCD 22A or CCD 24A. Another displayed instruction indicates that photographic image capture starts when the red button is manipulated, and another displayed instruction indicates that image capture ends when the blue button is manipulated. The image display areas 302 to 304 display captured images.

Referring back to FIG. 11, the CPU 131 determines at a step S47 whether image capture has been instructed to start or not. If the CPU 131 determines that it has not been instructed, the processing returns to the step S46 where the display of the select screen is continued. On the other hand, When the red button on the remote controller 66 is manipulated, the CPU 131 determines at the step S47 that the image capture has been instructed to start. In this case, the processing goes to a step S48 where the image capture is started.

In other words, the CCD 22A or CCD 24A is driven in accordance with the selection by a user to perform image capture. Images resulting from the shooting are displayed and given to the user on the screen as shown in FIG. 18.

The CPU 131 determines at a step S50 whether the image capture ends or not. If the CPU 131 determines that the image capture does not end, the processing returns to the step S46. Then, the step S46 and subsequent steps are repeated. On the other hand, if the CPU 131 determines at the step S50 to finish the image capture since the remaining capturable number of images reaches zero or since the user has instructed to finish the image capture, the processing goes to the step S26. Then, like the end of the theme image capture, an image and a number of divisions of the sticker sheet 121 are selected, and the image capture processing then ends.

After a predetermined number of shots are performed in the theme image capture mode, a user can shot in the normal image capture mode. Thus, a user can enjoy image capture in the theme image capture and can capture pictures with his/her preferred composition. As described above, by allowing a user free image capture in the normal image capture mode after image captureshooting in the theme image capture, that is, by flexibly coping with the changes of heart of the user, the wide variety of degrees of satisfaction can be obtained from the user.

Next, details of graffiti processing to be performed at the step S3 in FIG. 7 will be described with reference to a flowchart in FIG. 29.

At a step S61, the CPU 131 reads image data selected as an image data to do graffiti, and graffiti screens are displayed on the graffiti monitors 51-1 and 51-2.

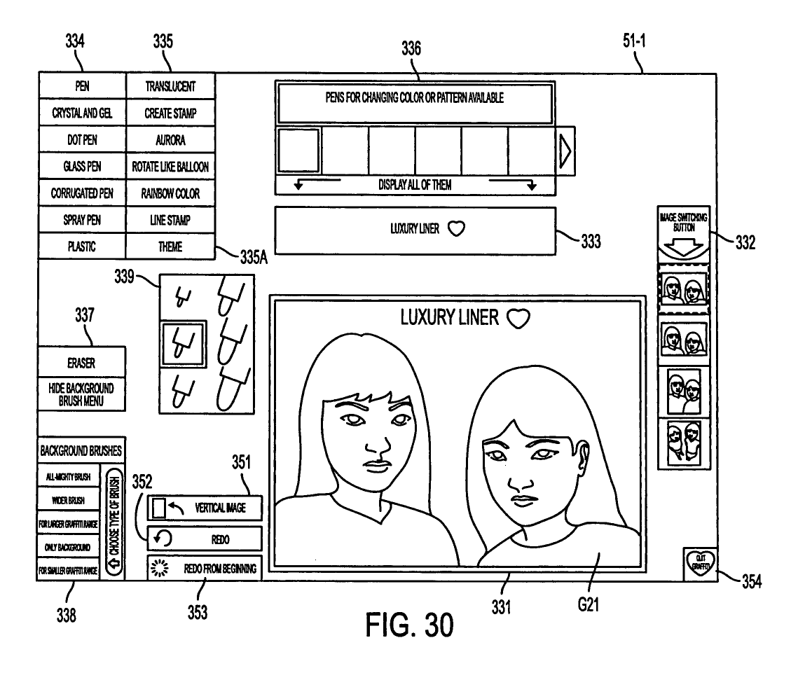

FIG. 30 is a diagram showing a display example of the graffiti screen.

FIG. 30 shows a display example of the graffiti monitor 51-1, and the same screen is displayed on the graffiti monitor 51-2.

For example, an image-for-graffiti display area 331 is enlarged and is displayed on the graffiti monitor 51-1. A user can select an image to be displayed on the image-for-graffiti display area 331 from a list of thumbnail images displayed on a thumbnail display area 332 by using the input pen 53-1. A list of images selected as images for graffiti during image capture processing is displayed on the thumbnail display area 332.

For example, when an image selected on the thumbnail display area 332 is an image captured in the theme image capture mode, the theme (corresponding to the image) given to a user for image capture is displayed in the theme display area 333 immediately above the image-for-graffiti display area 331.

In the example in FIG. 30, an image 21 displayed on the image-for-graffiti display area 331 is a image with a pose and/or expression associated with a theme, “Luxury Liner”. The text, “Luxury Liner” is displayed on the theme display area 333. A user can recognize the theme of a displayed image by checking the display and can do graffiti relating to the theme on the image for graffiti.

Various buttons for selecting graffiti tools are displayed near the image-for-graffiti display area 331.

For example, a pen menu 334 and a stamp menu 335 are displayed. The pen menu 334 is manipulated for selecting a “Pen Tool” for inputting lines and text on an image for graffiti. The stamp menu 335 is manipulated for selecting a “Stamp Tool” for arranging a predetermined stamp image on an image for graffiti.

A theme button 335A is provided on the lowest column of the stamp menu 335. Therefore, when an image G21 captured for the theme, “Luxury Liner” is displayed as an image for graffiti, and when the theme button 335A is manipulated, the text, “Luxury Liner” is input at a predetermined position of the image G21 for graffiti. The text, “Luxury Liner” displayed on the upper part of the image G21 in FIG. 30 is one input by manipulating the theme button 335A.

The graffiti screen displays a color select menu 336, an eraser menu 337, a range adjusting menu 338 and a thickness menu 339. The color select menu 336 is manipulated for selecting the color of, for example, text input by using a “Pen Tool”. The eraser menu 337 is manipulated for selecting an “Eraser Tool” for erasing, for example, input graffiti. The range adjusting menu 338 is manipulated for selecting a “Background Brush Tool” for arranging a preferred texture pattern on the background of an object and for selecting the range. The thickness menu 339 is manipulated for selecting the thickness of a “Pen Tool”.

Furthermore, a switch button 351 and redo buttons 352 and 353 are displayed on the graffiti screen. The switch button 351 is manipulated for switching the display the display direction (vertical direction and horizontal direction) of the image displayed on the image-for-graffiti display area 331. The redo button 352 is manipulated for canceling just input graffiti. The redo button 353 is manipulated for canceling all of input graffiti. A quit button 354 is displayed on the lower right part of the graffiti monitor 51-1. The quit button 354 is manipulated for quitting graffiti processing and starting printing.

Referring back to FIG. 29, when graffiti by using the tool selected on the touch panels 94-1 94-2 are input, the CPU 131 does graffiti on an image selected for graffiti in accordance with the input from a user at step S62. For example, a predetermined Pen Tool is selected from the pen menu 334 and when text is input on an image for graffiti, the CPU 131 displays an image corresponding to the input text over the image for graffiti.

The CPU 131 determines at a step S63 whether the graffiti processing ends or not. When the CPU 131 determines that the graffiti processing is not ended since the quit button 354 has not been manipulated, the processing returns to the step S62 where the above-described steps are repeated. On the other hand, when the quit button 354 has been manipulated or when a predetermined time limit expires, the CPU 131 determines at the step S63 that the graffiti processing is ended. Then the processing ends.

When the graffiti processing ends, the CPU 131 causes the graffiti monitors 51-1 and 51-2 to display a message for guiding a user to move to the print waiting space 75. The user moves to the print waiting space 75 by following the displayed message and waits until his/her sticker sheet is ejected from the sticker ejecting port 41.

After that, the processing goes to the step S4 in FIG. 7 where a composite image having graffiti input in the above-described manner is printed on the sticker sheet 121. In other words, data of a composite image having input graffiti is output to the printer portion 111 by the control device 91. The composite image is printed on the sticker sheet 121 based on the data. The sticker sheet 121 on which the composite image is printed is ejected from the sticker ejecting port 41.

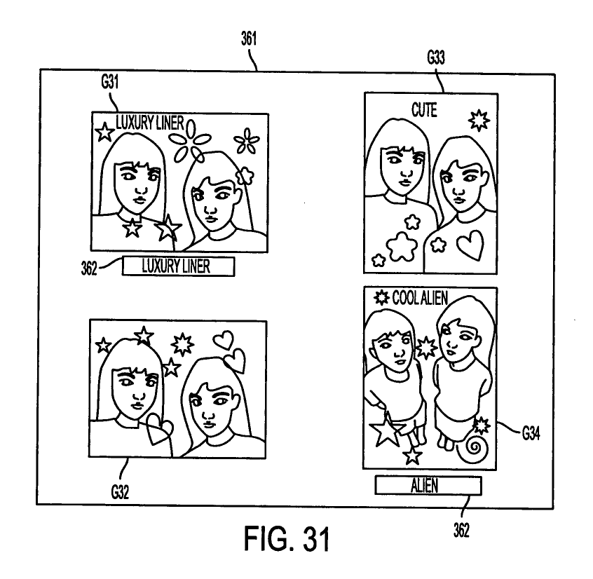

FIG. 31 is a diagram showing an example of a sticker sheet printed and ejected from the sticker ejecting port 41 by the photo sticker vending machine 1.

As shown in FIG. 31, images G31 to G34 having graffiti such as text and figures are printed on a sticker sheet 361 in accordance with the number of divisions (four divisions) set by a user.

Text, “CUTE” (image G33) and “COOL” (image G34) and stamp images in heart and star shapes around an image of an object (human figure) or partially over the image of the object on the graffiti image in FIG. 31 are graffiti image input by a user. In this way, a user can render an image such as preferred text on his/her captured image.

The text, “Luxury Liner” displayed on the upper left of the image G31 and text, “Alien” displayed on the upper right of the image G34 represent themes of the images (image capture compositions). In other words, a user does graffiti on the images G1 and G34, manipulates the theme button 335A and inputs the themes corresponding to the images.

A theme corresponding to a given image may be printed near the image captured in accordance with the theme. In the example shown in FIG. 31, the image G31 is an image captured in accordance with a given theme, “Luxury Liner”. In this case, the text, “Luxury Liner” is printed on a theme printing area 361 immediately under the image G31. Similarly, the text, “Alien” is printed in a theme printing area 361 immediately below the image G34 captured in accordance with the theme, “Alien”.

In this way, by looking at the sticker sheet 121 on which images and themes corresponding to the image are printed, a user can recognize themes of images later. Furthermore, users looking at the result can get more excited.

In the graffiti processing, for example, graffiti tools (such as a background brush, pen and stamp) can be automatically selected in accordance with the theme of an image for graffiti.

More specifically, when an image captured in accordance with a theme, “UFO”, is an image for graffiti, a background brush tool, a green pen tool or a stamp tool may be selected as a default graffiti tool. The background brush tool is user for producing, with graffiti, a situation in which a UFO can appear, for example. The green pen tool is for drawing a sticker pattern like the blood of aliens. The stamp tool is user for inputting, for example, images of UFOs in various shapes, an image of an UFO emitting a strange light beam, an image of a state where an alien comes down from a UFO and an image of the same serial UFOs.

A layer of a captured image and a layer of graffiti image input by a user during graffiti processing may be managed independently for the color correction in printing such that the amount of correction can be controlled for each of the layers.

For example, the correction of each layer of a captured image may be controlled. Thus, the color of a skin color area can be corrected to a so-called memorized skin color. On the other hand, the correction opposite against the correction on the layer of the captured image can be performed on an area to be printed over the skin color area of the layer of the graffiti image.

Thus, each layer can have a more suitable color than a case where a captured image and graffiti image are managed in one single layer and the same correction is performed on both of the images. As a result, the sticker sheet on which the composite image of the captured image and graffiti image is printed can have the best suitable developed color.

What is claimed as new and desired to be protected by Letters Patent of the United States is:

1. A photo sticker vending machine, comprising;
output means for outputting a theme conceptually representing an image composition with an object; and
image capture means for capturing an image of the object to which the theme is given by the output means.

2. A photo sticker vending machine according to claim 1, wherein the output means outputs the theme by text or by voice.

3. A photo sticker vending machine according to claim 1, further comprising selecting means for randomly selecting from among a plurality of themes, wherein the output means outputs the theme selected by the selecting means.

4. A photo sticker vending machine according to claim 3, further comprising display means for displaying said plurality of themes,
wherein the output means outputs the theme selected from the plurality of themes displayed by the display means.

5. A photo sticker vending machine according to claim 1, further comprising graffiti means for creating graffiti on an image capture by the image capture means,
wherein the graffiti means inputs, to the image for graffiti, information representing the theme corresponding to the image for graffiti.

6. A photo sticker vending machine according to claim 5, further comprising printing means for printing on a sticker sheet an image captured by the image capture means or an image on which graffiti are created by the graffiti means, wherein the printing means prints the theme corresponding to the image to be printed near the image graffiti to be printed.

7. A method of capturing a photo image in a photo sticker vending machine, comprising the steps of:
outputting a theme conceptually representing an image composition with an object; and
capturing an image of the object to which the theme is given by the output means.

8. A sticker sheet to be printed by a photo image capture method in a photo sticker vending machine, the method comprising the steps of:
outputting a theme conceptually representing an image composition with an object; and
capturing an image of the object to which the theme is given by the output means.

9. A sticker sheet unit used in a photo sticker vending machine, the machine comprising:
output means for outputting a theme conceptually representing an image composition to an object; and
image capture means for capturing an image of the object to which the theme is given by the output means,
the sticker sheet unit comprising:
identification information storing means for storing identification information for identifying the sticker sheet unit,
wherein the sticker sheet unit is usable when the identification information stored by the identification information storing means is authenticated by the photo sticker vending machine.

10. A photo sticker vending machine according to claim 2, further comprising selecting means for randomly selecting from among a plurality of themes, wherein the output means outputs the theme selected by the selecting means.

11. A photo sticker vending machine according to claim 2, further comprising graffiti means for creating graffiti on an image capture by the image capture means,
wherein the graffiti means inputs, to the image for graffiti, information representing the theme corresponding to the image for graffiti.

12. A photo sticker vending machine according to claim 3, further comprising graffiti means for creating graffiti on an image capture by the image capture means,
wherein the graffiti means inputs, to the image for graffiti, information representing the theme corresponding to the image for graffiti.

13. A photo sticker vending machine according to claim 4, further comprising graffiti means for creating graffiti on an image capture by the image capture means,
wherein the graffiti means inputs, to the image for graffiti, information representing the theme corresponding to the image for graffiti.
